(19) United States
(12) Patent Application Publication
(10) Pub. No.: US 2016/0192674 A1
(43) Pub. Date: Jul. 7, 2016

(54) CHEWING GUM COMPOSITION COMPRISING A MICRO-ENCAPSULATED FLAVOUR IN A MATRIX COMPRISING PROTEIN

(71) Applicant: INTERCONTINENTAL GREAT BRANDS LLC, East Hanover, NJ (US)

(72) Inventors: Rufino PEREZ, Glenview, IL (US); Anilkumar Ganapati GAONKAR, Glenview, IL (US); Ahmad AKASHE, Glenview, IL (US); Rachel COATES, Whippany, NJ (US); Theodore ANASTASIOU, Whippany, NJ (US); Radha BHEEMREDDY, East Hanover, NJ (US)

(21) Appl. No.: 14/916,594

(22) PCT Filed: Sep. 12, 2014
(86) PCT No.: PCT/US14/55322

§ 371 Date: Mar. 4, 2016

Related U.S. Application Data
(60) Provisional application No. 61/876,910, filed on Sep. 12, 2013.

(51) Int. Cl. A23G 4/16; A23G 4/06; A23G 4/20

(52) U.S. Cl. CPC A23G 4/16; A23G 4/20; A23G 4/066; A23V 2002/00

(57) ABSTRACT

A chewing gum composition comprising; (a) a gum base; and (b) at least one microencapsulated composition comprising at least one active component and a matrix to at least partially microencapsulate the at least one active component; the at least one active component comprising at least one oil-soluble flavoring agent and the matrix comprising dewatered protein precipitate.

### BACKGROUND OF THE INVENTION

Chewing gum manufacturers have long endeavored to provide longer lasting flavors in chewing gums. In one approach to prolonging flavor, ingredients including flavors, sweeteners, and food-grade acids (to provide sourness) have been encapsulated with polymers to delay and prolong their release. See, for example, U.S. Pat. Nos. 4,931,293, 5,057,328, 5,064,658, and 5,110,608 to Cherukuri et al.

U.S. Pat. No. 3,826,847 discloses the coating, encapsulation or combination of flavoring agents with high molecular weight compounds including starches, cellulose, proteins, gums, polyvinyl alcohol and polyvinyl esters. The encapsulated particles are then distributed in the gum base.

U.S. Pat. No. 4,485,118 teaches the encapsulation of flavoring agents with water-insoluble materials including certain vinyl polymers, polyolefins, polyesters, waxes, gums, protein end the like.

U.S. Pat. No. 4,515,769 teaches an encapsulated flavorant composition for use in chewing gum compositions. This composition is prepared by the steps of forming an emulsion of flavoring agent in a partially hydrophilic matrix material comprising gelatin, a natural gum or albumin and plasticizer; drying the emulsion to a solid matrix; grinding to a solid base powder; and then coating the base powder with a water insoluble material which will prevent elution of flavor from the base powder and will not immediately dissolve under the hydrolytic condition of the mouth yet which, when chewed, or otherwise worked in the mouth, will give a substantial flavor “burst” and sustained flavor release as the hydrophilic base powder matrix is wetted in the mouth. The encapsulated flavorant composition may be used in chewing gum.

U.S. Published Patent Application No. 2009/0162485 teaches a method for preparing aggregates of protein micelles and an active agent, which comprises dispersing whey protein micelles and the active agent in a liquid; and forming aggregates of the whey protein micelles and the active agent by removal of the liquid.

U.S. Published Patent Application No. 2011/0159103 discloses hydrophobic liquids micro capsulated by an enteric matrix in an environment substantially free of organic solvents. The process in this Published Patent Application includes forming an emulsion of the enteric material and a hydrophobic liquid in water, titrating the emulsion with acid to form a particulate with a combination of enteric material and plasticizer.

U.S. Pat. No. 6,375,983 discloses an encapsulated fragrance in which the fragrance can be released by exposing it to a solution at a predetermined pH. The invention also contemplates a process for preparing encapsulated fragrances using specific polymeric-based encapsulation process and the melt of protein which are further used as coating material.

A need still exists for the protection and stabilization of flavors, especially volatile flavors, which can then be incorporated into gum bases and chewing gum compositions and provide the attribute of longer-lasting flavor perception upon chewing.

### BRIEF DESCRIPTION OF EMBODIMENTS OF THE INVENTION

One embodiment is a chewing gum composition comprising; (a) a gum base; and (b) at least one microencapsulated composition useful for delivering at least one active component at a desired release rate, comprising the at least one active component and a matrix that at least partially microencapsulates the at least one active component; the at least one active component comprising at least one oil-soluble flavoring agent and the matrix comprising dewatered protein precipitate.

Another embodiment is a chewing gum composition comprising;

(a) a gum base; and (b) at least one microencapsulated composition useful for delivering at least one active component at a desired release rate, comprising the at least one active component and a matrix that at least partially microencapsulates the at least one active component; the at least one active component comprising at least one oil-soluble flavoring agent, and at least one vapor suppressant and the matrix comprising dewatered sodium caseinate precipitate and at least one film forming agent; wherein the at least one microencapsulated composition further comprises a first coating that substantially surrounds the at least one active component that is at least partially encapsulated by the matrix; and wherein the at least one microencapsulated composition is from about 20 microns to about 500 microns.

Another embodiment is method for preparing a delivery system for a chewing gum composition comprising: (1) agitating a mixture comprising water and protein material at a pH so that the protein material is soluble in the water to form a solution; (2) mixing a hydrophobic liquid containing an oil-soluble flavoring agent into the solution; (3) homogenizing the hydrophobic liquid and the solution to create an emulsion; (4) acid titrating the emulsion with an amount of acid to form a precipitate of the hydrophobic liquid microcapsulated in the protein material; (5) dewatering the microcapsulated, particulated precipitate to form a dried microcapsulated product; and (6) grinding the dried microcapsulated product to an average particle size of about 20 microns to about 500 microns; thereby forming a delivery system of an oil-soluble flavoring agent microcapsulated in dewatered protein precipitate.

Still another embodiment is a method of preparing a chewing gum composition containing a delivery system useful for delivering at least one active component at a desired release rate, said method comprising: (1) agitating a mixture comprising water and protein material at a pH so that the protein material is soluble in the water to form a solution; (2) mixing a hydrophobic liquid containing an oil-soluble flavoring agent into the solution; (3) homogenizing the hydrophobic liquid and the solution to create an emulsion; (4) acid titrating the emulsion with an amount of acid to form a precipitate of the hydrophobic liquid microcapsulated in the protein material; (5) dewatering the microcapsulated particulated precipitate to form a dried microcapsulated product; (6) grinding the dried microcapsulated product to an average particle size of about 20 microns to about 500 microns; thereby forming a delivery system of an oil-soluble flavoring agent microcapsulated in dewatered protein precipitate; and (7) mixing the delivery system with a gum base to yield a chewing gum composition.

In the various optional embodiments, (1) the protein is a milk protein such as sodium caseinate; (2) the at least one oil-soluble flavoring agent is chosen from synthetic flavor oils, natural flavoring aromatics, natural flavoring aromatics oils, oleoresins, extracts derived from plants, leaves, flowers, fruits; (3) the at least one oil-soluble flavoring agent is chosen from spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils, fruit essences, mints, artificial vanilla, cinnamon derivatives, oil-soluble cooling agents and combinations thereof; (4) the at least one oil-soluble flavoring agent is banana oil (isoamyl acetate); (5) the at least one oil-soluble flavoring agent is pre-blended with at least one vapor pressure suppressant such as at least one medium chain triglyceride (MCT) or a low molecular weight polymer, wherein the weight ratio of the at least one oil-soluble flavoring agent to the at least one vapor pressure suppressant is from about 20:1 to 4:1 by weight; (6) the low molecular weight polymer is at least one polyvinyl acetate, at least one ester gum or mixtures thereof; (7) the at least one active component is from about 1% to about 50% by weight of the at least one microencapsulation composition or weight ratio of dewatered protein precipitate to the at least one active ingredient is from about 10:1 to 1:1; (8) the matrix further comprises at least one film-forming material such as shellac or zein or mixtures thereof and the weight ratio of dewatered protein precipitate to at least one film-forming material is from about 10:1 to about 5:1; (9) the matrix further comprises at least one crosslinking agent such as transglutaminase and the weight ratio of dewatered protein precipitate to at least crosslinking agent is from about 10:1 to about 5:1; (10) the at least one microencapsulated composition further comprises one or more coatings overlying the at least one microencapsulated composition; wherein one or more coatings overlying the at least one microencapsulated composition comprises a first hydrophobic coating that completely surrounds the at least one microencapsulated composition and a second coating that substantially surrounds the first coating; (11) the first coating comprising ethyl cellulose; (12) the second coating comprising a hydrophilic coating chosen from gum arabic, maltodextrin, pectin, gelatin, hydrophilic cellulosic derivatives and mixtures thereof; (13) the hydrophilic cellulosic derivatives are chosen from carboxymethyl cellulose and hydroxypropyl cellulose; (14) the at least one microencapsulated composition has a number average particle size from about 20 microns to about 500 microns; and (15) and combinations of these optional embodiments.

These and other embodiments are described in detail below.

### BRIEF DESCRIPTION OF THE FIGURES

FIG. 1 is a bar chart showing the average percent flavor load in a control gum of Comparative Example 1 at different points of time after manufacture and after chewing began.

FIG. 2 is a bar chart showing the average percent flavor load in a control gum of Example 1 at different points of time after manufacture and after chewing began.

FIG. 3 is a bar chart showing the average percent flavor load in a control gum of Example 2 at different points of time after manufacture and after chewing began.

### DETAILED DESCRIPTION OF THE INVENTION

The present invention is directed to a delivery system used to extend or delay the release of a flavor from an oral composition such as chewing gum and the like.

In some embodiments, the chewing gum composition can include a gum base and any of the microencapsulated compositions described herein. In some embodiments, some or the entire flavoring agent is in an encapsulated form. As a further alternative, chewing gum compositions can include some of the flavoring agent in an encapsulated form and some of the flavoring agent in a free form. In some embodiments, the chewing gum may include two or more encapsulated flavoring agents.

As used herein, the term “microencapsulated composition” and other similar terminology refers to a core such as at least one active ingredient that it is at least partially encapsulated with the matrix or encapsulating material. The microcapsule formed herein has an internal reservoir-containing structure where the flavoring agent is entrapped. The matrix or encapsulating material is comprised of dewatered protein precipitate. The protein may be a milk protein such as sodium caseinate. The microencapsulated composition can optionally further comprise additional ingredients besides the oil-soluble flavoring agents and the dewatered protein precipitate. For example, film forming materials such as shellac and zein may be added to the microencapsulated composition.

As used herein, the term “microencapsulate”, “encapsulate,” “encapsulates,” “microencapsulation” or other similar terminology refers to a coating layer or matrix including milk protein such as sodium caseinate that either at least partially surrounds a core or at least one active ingredient agent. The coating layer or matrix that includes milk protein such as can also herein be referred to as “a microencapsulation material,” “an encapsulation material,” “encapsulation layer,” or “encapsulation matrix.”

As used herein, the term “at least partially” when used in the context of the encapsulated core or at least one active component or material means that the microencapsulating material either partially or completely surrounds or encapsulates the flavoring agent.

As used herein, the term “dewatered protein precipitate” refers to particles of protein-containing material that are made from an aqueous (oil-in-water; o/w) emulsion that is acid titrated to produce a precipitate of the protein material in the aqueous phase. The protein precipitate is then separated from the aqueous phase by dewatering and drying in one or more steps or stages. The dewatered protein precipitate is then ground to the desired particle size to product free flowing microcapsules. The dewatered protein precipitate contains less than 5% water by weight, preferably less than 3% water by weight, more preferably from 0.01% to 2% water by weight.

The active ingredient used as the core in the microencapsulant composition herein includes any oil-soluble flavoring agent useful in delivery systems for chewing gum compositions. As used herein, the term “at least one oil-soluble flavoring agent” refers to any at least one oil-soluble flavoring agent that can be used in as chewing gum composition. The at least one oil-soluble flavoring agent may be chosen from synthetic flavor oils, natural flavoring aromatics, natural flavoring aromatics oils, oleoresins, extracts derived from plants, leaves, flowers, fruits. Specific examples include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, and combinations thereof. Specific flavorants are mints such as peppermint, spearmint, artificial vanilla, cinnamon derivatives, and various fruit flavors. In some embodiments, it is desirable to use a volatile oil-soluble flavoring agent such as banana oil (isoamyl acetate).

In order to better protect the flavoring agent, it is sometimes desirable to pre-blend the flavoring agent with at least one vapor pressure suppressant to lower the vapor pressure of the flavoring agent such as at least one medium chain triglyceride (MCT) or at least one oil-soluble, low molecular weight polymer. One particularly desirable medium chain triglyceride is Neobee M-5 oil available from the Stepan Company of Northfield, Ill. Examples of such low molecular weight polymers include at least one polyvinyl acetate or at least one ester gum or mixtures thereof. As used herein, the term “lower molecular weight” means a number average molecular weight below 100,000. When one or more vapor pressure suppressants are used, the weight ratio of the at least one oil-soluble flavoring agent to the at least one vapor pressure suppressant is from about 20:1 to 4:1 by weight. These vapor pressure suppressants may react with the flavoring agent and thus stabilize the flavoring agent during processing and help providing for better control of the flavor release profile during chewing. The use of vapor pressure suppressants is especially useful with volatile flavoring agent such as banana oil.

In one embodiment, the at least one active component is from about 1% to about 50% by weight of the at least one microencapsulation composition.

In some embodiments herein, the design of a protein-based microencapsulation system provides the advantage for efficient flavor protection during microencapsulation process, during storage, and during the later chewing gum making process and aging. In addition, the flavor-containing microcapsules can effectively stand further coating steps that offer further protection to the flavoring agent. This protein-based microencapsulation system enhances the extension of flavor release during chewing, with a sustained release beyond ten minutes of chew. Also, these characteristics allow for the use of less flavor during formulation and production, while providing increased, more consistent and/or long lasting flavor during the chew.

In one embodiment, the dewatered protein precipitate can be present in an amount of about 35 to about 90 weight percent of the microencapsulated composition and at least one active ingredient to form a microencapsulated composition; In other embodiments, the dewatered protein precipitate is present in an amount of about 35 to about 80 weight percent, specifically about 35 to about 75 weight percent, more specifically about 40 to about 60 weight percent of the microencapsulated composition. The weight ratio of dewatered protein precipitate to the at least one active component is from about 10:1 to 1:1 in any of those embodiments.

The encapsulating material may be solely dewatered protein precipitate or may be a mixture of dewatered protein precipitate with one or more other ingredients. These other ingredients may include one or more film-forming agents such as shellac or zein or combinations thereof. These additional film-forming agents may provide additional protection to the active ingredient and allow for more exact flavor release profile during chewing. In addition, to further improve the encapsulating material, the dewatered protein precipitate may be crosslinked with cross linking agents such as transglutaminase, aldehydes and phenolic compounds and combinations thereof. The presence of a cross-linking agent such as transglutaminase is believed to enhance the formation of covalent bonding between free amine groups and peptide-bound glutamine. In addition, the use of a cross-linking agent in the encapsulating material allows for more protection to the active component while also providing for better control of the flavor release profile during chewing.

If one or more film-forming agents are used, the weight ratio of protein material to one or more film-forming agents is from about 10:1 to about 1:10. If one or more crosslinking agent or agents such as transglutaminase is used, the weight ratio of the protein material to the one or more crosslinking agent or agents is from about 10:1 to 1:10.

The method for preparing a delivery system for a chewing gum composition comprises the following steps: First, agitating a mixture comprising water and protein material at a pH so that the protein material is soluble in the water to form a solution. The weight ratio of water to protein should be sufficient to allow the protein material to go into solution. Optionally, the other film-forming agents may be added to this solution. Second, mixing a hydrophobic liquid containing an oil-soluble flavoring agent (and optionally the pre-blended vapor suppressant agents) into the solution. Three, homogenizing the hydrophobic liquid and the solution to create an emulsion. This homogenizing step can be carried out in any suitable homogenizing apparatus. Four, acid titrating the emulsion with an amount of acid to form a precipitate of the hydrophobic liquid microcapsulated in the protein material. Citric acid is a preferred acid to use with milk protein; however, any food acid may be employed. In the case of a milk protein such as sodium caseinate, the pH of the emulsion is adjusted with the addition of the citric acid to below the isoelectric point (pH=4.5) to induce precipitation and wet granulation. Separately, cross-linking agents may be added after the precipitate occurs. Five, dewatering the microcapsulated particulated precipitate to form a dried microcapsulated product. This dewatering step may be carried out in one or more steps. In one embodiment, the resulting wet granular mixture is first partially dewatered by pressing the precipitated protein and flavor-containing curd through a mesh under pressure. The resulting partially dried mix is then coarsely ground and then oven-dried at 60 degrees C. for approximately one hour until the moisture was about 2% by weight. Six, grinding the dried microcapsulated product to a number average particle size of about 20 microns to about 500 microns; thereby forming a delivery system of an oil-soluble flavoring agent microcapsulated in dewatered protein precipitate.

The microencapsulated composition thus made may be coated one or more coatings overlying the microencapsulated composition. These coating may be either hydrophobic or hydrophilic in nature or may be combinations of hydrophobic or hydrophilic coatings in any order. In some embodiments, the one or more hydrophobic coating are applied first, followed by one or more hydrophilic coatings. In other embodiments, the opposite order of coating is employed. In each case, these additional coatings further protect the flavor agent during storage, during chewing gum making, and provide further control of the release of the flavoring agent during chewing. Hydrophilic coatings such as gum arabic, maltodextrin, and pectin, gelatin, hydrophilic cellulosic derivatives and combinations thereof also provide the benefit of the enhancement of flavor release upon chewing, through the creation of hydrophilic interface between the hydrophobic gum base and the hydrophilic saliva.

In some particular embodiments, two coatings overlying the microencapsulated composition are applied. A first hydrophobic coating that completely surrounds the microencapsulated composition is applied and then a second hydrophilic coating that substantially surrounds the first coating is applied. In one embodiment, the first hydrophobic coating comprises ethyl cellulose and the second hydrophilic coating is chosen from gum arabic, maltodextrin, pectin, gelatin, hydrophilic cellulosic derivatives and mixtures thereof. These coating steps may be carried out with a conventional coating process used in making of coated chewing gum products. In one embodiment, the microcapsules are first coated in a fluidized bed of moving air with a solution of the ethyl cellulose dissolved in ethyl alcohol as the solvent. The coated particles are then coated in a fluidized bed of moving air with a solution of the gum arabic, maltodextrin, pectin, gelatin, hydrophilic cellulosic derivatives and mixtures thereof dissolved in water as the solvent. The parameters used in such fluidized bed operations would be well known to the ordinary skilled artisan in the encapsulation art.

After the one or more coating are applied, these coated microencapsulated compositions have generally about 20 microns to about 500 microns number average particle size. In some case the number average particle size is from 70 to 200 microns.

In some embodiments, combinations of different microencapsulated compositions as described above may be used together in chewing gum compositions. For example, combinations of different microencapsulated compositions having different flavoring agents may be used together in chewing gum compositions. Alternatively, combinations of different microencapsulated compositions having different encapsulation materials may be used together in in a chewing gum composition. Also, combinations of different microencapsulated compositions having same flavoring agent, but some of the flavoring agent being pre-blended with a vapor suppression agent, may be used together in in a chewing gum compositions.

After completion of the forming of these microencapsulated compositions, either with or without one or more coatings, they are ready to be combined with a gum base composition to be used in a chewing gum composition.

### Chewing Gum Compositions

As used herein, the terms “gum,” “chewing gum,” and “bubble gum” are used interchangeably and are meant to include any gum composition. With regard to chewing gum compositions, such compositions contain a gum base, the microencapsulated composition, and various additives.

The microencapsulated composition is incorporated into a chewing gum. The chewing gum includes a gum base and unencapsulated flavoring agents or sweetener or both in addition to the microencapsulated composition. The amount of the microencapsulated composition can be about 0.25 to about 11 weight percent, specifically about 1 to about 10 weight percent, more specifically about 2 to about 9 weight percent, even more specifically about 3 to about 7 weight percent, based on the weight of the chewing gum composition. In some embodiments, the microencapsulated composition is present in a chewing gum composition in a particulate form having a number average particle size less than or equal to about 500 micrometers. In some embodiments, the microencapsulated composition is present in a chewing gum composition in a particulate form having a number average particle size of about 20 to about 500 micrometers, specifically about 30 to about 450 micrometers, more specifically about 70 to about 200 micrometers. In some embodiments the microencapsulated composition is present in a chewing gum composition in a particulate form having a number average particle size of about 420 micrometers.

Besides the microencapsulated composition, the chewing gum composition generally comprises a gum base, bulk sweeteners, high intensity sweeteners, flavorants, coloring agents, warming agents, cooling agents, tingling agents, and any other optional additives, including throat-soothing agents, spices, tooth-whitening agents, breath-freshening agents, vitamins, minerals, probiotics, caffeine, drugs (e.g., medications, herbs, and nutritional supplements), oral care products, and combinations comprising at least one of the foregoing.

Generally, the chewing gum composition comprises a water-insoluble gum base portion and a bulk portion comprising of additional ingredients (also known as additives). The gum base can vary greatly depending upon various factors such as the type of base desired, the consistency of gum desired, and the other components used in the composition to make the final chewing gum product. In some embodiments, the chewing gum base is present in an amount of about 5 to about 90 weight percent, where the weight percent is based on the total weight of the chewing gum composition. Within the range of about 5 to about 90, the water-insoluble gum base can be present in an amount of about 10 to about 50 weight percent, specifically the gum base can be present in an amount of about 15 to about 40 weight percent, and even more specifically the gum base can be present in an amount of about 20 to about 30 weight percent.

As used herein, the term “water-soluble” encompasses compounds, which possess a water solubility of at least 1 gram/liter at 25 degree Celsius. As used herein, the term “water-insoluble” encompasses compounds, which possess a water solubility of less than at least 1 gram/liter at 25 degree Celsius.

The gum base can be any water-insoluble gum base known in the art, and includes those gum bases utilized for chewing gums and bubble gums. Illustrative examples of suitable polymers in gum bases include both natural and synthetic elastomers and rubbers. For example, natural elastomers and rubbers include substances of vegetable origin such as smoked or liquid latex and guayule, natural gums such as jelutong, lechi caspi, perillo, sorva, massaranduba balata, massaranduba chocolate, nispero, rosidinha, crown gum, chicle, gutta percha, gutta kataiu, gutta kay, niger gutta, tunu, chilte, chiquibul, gutta hang kang, or the like, and mixtures thereof.

Synthetic elastomers include high- and low-molecular weight elastomers. Useful high molecular weight elastomers include butadiene-styrene copolymers, polyisoprene, polyisobutylene, isobutylene-isoprene copolymers, polyethylene, combinations thereof, and the like. Useful low-molecular weight elastomers include polybutene, polybutadiene, polyisobutylene, and combinations thereof. Suitable gum bases can also include vinyl polymeric elastomers such as poly(vinyl acetate) (PVA), polyethylene, vinyl copolymeric elastomers such as copolymers of vinyl acetate and vinyl laurate, copolymers of vinyl acetate and vinyl stearate, copolymers of ethylene and vinyl acetate, poly(vinyl alcohol) and combinations thereof. When utilized, the number average molecular weight of the vinyl polymers can range about 3,000 to about 94,000. Vinyl polymers such as poly(vinyl alcohol) and poly(vinyl acetate) (when employed in the gum base, as distinguished from the encapsulated sweetener composition) can have a number average molecular weight of about 8,000 to about 65,000. Furthermore, any combination of the aforementioned high- and low-molecular weight, natural and synthetic elastomers, and rubbers can be used as a gum base. The polymers can be present in an amount of about 35 to about 95 weight percent, based on the weight of the gum base.

The amount of gum base employed will vary greatly depending upon various factors such as the type of base used, the consistency of the gum desired, and the other components used in the composition to make the final chewing gum product. In general, the gum base will be present in an amount of about 5 to about 94 weight percent of the final chewing gum composition. In some embodiments, the gum base amount is about 15 to about 45 weight percent, specifically about 20 to about 43 weight percent, more specifically about 30 to about 40 weight percent, based upon the total weight of the chewing gum composition.

The water-insoluble gum base portion can further additionally contain any combination of elastomer plasticizers, waxes, softeners, bulking agents and other optional ingredients such as colorants and antioxidants. Elastomer plasticizers are also commonly referred to as resins, resinous compounds, elastomer solvents, or rosins. Additives that can be included in the gum base include plasticizers, waxes or softeners that are used in effective amounts to provide a variety of desirable textures and consistency properties. Because of the low molecular weight of these components, the texture modifying agents are able to penetrate the fundamental structure of the gum base making it more plastic and less viscous.

The gum base composition can contain conventional elastomer plasticizers to aid in softening the elastomer base component, for example terpene resins such as polymers derived from alpha-pinene beta-pinene, and/or d-limonene; methyl, glycerol or pentaerythritol esters of rosins or modified rosins and gums, such as hydrogenated, dimerized or polymerized rosins, or combinations comprising at least one of the foregoing resins; the pentaerythritol ester of partially hydrogenated wood or gum rosin; the pentaerythritol ester of wood or gum rosin; the glycerol ester of wood rosin; the glycerol ester of partially dimerized wood or gum rosin; the glycerol ester of polymerized wood or gum rosin; the glycerol ester of tall oil rosin; the glycerol ester of wood or gum rosin; the partially hydrogenated wood or gum rosin; the partially hydrogenated methyl ester of wood or rosin; and the like. Any combination of the foregoing elastomer plasticizers can be used to soften or adjust the tackiness of the elastomer base component. The elastomer plasticizer can be used in an amount of about 5 to about 75 weight percent of the gum base, specifically about 45 to about 70 weight percent of the gum base. In some embodiments, the chewing gum composition further contains a gum base softener. In some embodiments, the softener is present in amounts of up to about 30 weight percent of the gum base, specifically about 3 to about 20 weight percent of the gum base. In some embodiments, the softeners can be present in amounts of up to about 30 weight percent of the gum base, specifically about 0.1 to about 20 weight percent of the gum base, more specifically about 0.1 to about 4 weight percent of the gum base, still more specifically about 0.20 to about 2.5 weight percent of the gum base, and even more specifically about 0.5 to about 1.7 weight percent of the gum base. Suitable softeners include lanolin, palmitic acid, oleic acid, stearic acid, fatty acids, sodium stearate, potassium stearate, glyceryl triacetate, glyceryl lecithin, glyceryl monostearate, propylene glycol monostearate, mono-, di- and triglycerides, acetylated monoglyceride, glycerine, lecithin, diacetin, and combinations thereof. Other suitable softeners include waxes. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, cocoa butter, propylene glycol, and the like can also be incorporated into the gum base to obtain a variety of desirable textures and consistency properties. The waxes employed can have a melting point below about 60 degrees Celsius, and preferably about 45 to about 55 degrees Celsius. The low melting wax can be a paraffin wax. The wax can be present in the gum base in an amount about 6 to about 10 weight percent, and preferably about 7 to about 9.5 weight percent, based on the total weight of the gum base. In addition to the low melting point waxes, waxes having a higher melting point can be used in the gum base in amounts up to about 5 weight percent based on the weight of the gum base. Such high melting waxes include beeswax, vegetable wax, rice bran wax, candelilla wax, carnauba wax, polyethylene wax, microcrystalline wax, petroleum waxes, and the like, and mixtures thereof.

The gum base can include effective amounts of bulking agents such as mineral adjuvants, which can serve as fillers and textural agents. Suitable mineral adjuvants include calcium carbonate, magnesium carbonate, alumina, aluminum hydroxide, aluminum silicate, talc, tricalcium phosphate, and the like, which can serve as fillers and textural agents. These fillers or adjuvants can be used in the gum base in various amounts and are in addition to the filler in the encapsulated sweetener composition. Specifically the amount of filler, when used, will be present in an amount of about 15 to about 40 weight percent, specifically about 20 to about 30 weight percent, based on the weight of the gum base.

In addition to the water insoluble gum base portion, a typical chewing gum composition includes a water soluble bulk portion and one or more flavoring agents. In some embodiments, the sweetener is present in a water soluble bulk portion of the chewing gum composition. The water soluble bulk portion can include one or more additional ingredients selected from the group consisting of sweetening agents, flavorants or flavoring agents, flavor modulators or potentiator, aroma agents, cooling agents, warming agents, coloring agents, breath fresheners, mouth moisteners, humectants, food-grade acids, buffering agents, tingling agents, effervescing agents, mouth moisteners, oral care agents, throat care agents, medicaments, antioxidants, preservatives, and combinations thereof. Some of these additional ingredients can serve more than one purpose. For example, a sweetening agent such as sucrose, sorbitol, other sugar alcohols, and combinations thereof can also function as a bulking agent. A combination comprising at least one of the foregoing additional ingredients is often used.

In some embodiments, the gum composition includes one or more unencapsulated active ingredients in addition to the encapsulated flavorant agent composition. The additional active ingredients can be unencapsulated active ingredients, encapsulated active ingredients or mixtures thereof. Any of the active ingredients herein described can be used as the additional active ingredient. In one embodiment, the unencapsulated active ingredients are present in an amount about 0.1 to about 50 weight percent based upon the total weight of the chewing gum composition. In one embodiment, the unencapsulated active ingredients are present in an amount about 0.1 to about 2.0 weight percent based upon the total weight of the chewing gum composition, specifically about 0.25 to about 1.5 weight percent, more specifically about 0.5 to about 1.0 weight percent of the chewing gum composition. In another embodiment, the unencapsulated active ingredients are present in an amount about 9.0 to about 49.0 weight percent based upon the total weight of the chewing gum composition, specifically about 9.0 to about 39.0 weight percent, more specifically about 10.0 to about 35.0 weight percent of the chewing gum composition.

In some embodiments, the chewing gum includes a sweetening agent to provide a sweet taste to the gum composition. Sweetening agents can include sugar sweeteners, sugarless sweeteners, high intensity sweeteners, or a combination of at least two of the foregoing sweetening agents.

Sugar sweeteners generally include saccharides. Suitable sugar sweeteners include monosaccharides, disaccharides, and polysaccharides such as sucrose (sugar), dextrose, maltose, dextrin, xylose, ribose, glucose, mannose, galactose, fructose (levulose), lactose, invert sugar, fructooligosaccharide syrups, partially hydrolyzed starch, corn syrup solids, such as high fructose corn syrup, and mixtures thereof.

Suitable sugarless sweetening agents include sugar alcohols (or polyols) such as sorbitol, xylitol, mannitol, galactitol, maltitol, hydrogenated isomaltulose (isomalt), lactitol, erythritol, hydrogenated starch hydrolysate, stevia and mixtures thereof. Suitable hydrogenated starch hydrolysates include those disclosed in U.S. Pat. No. 4,279,931 to Verwaerde et al. and various hydrogenated glucose syrups and/or powders, which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Also useful are mixtures of hydrogenated starch hydrolysates, such as those sold under the trade name LYCASIN by Roquette Freres of France, and those sold under the trade name HYSTAR by Lonza, Inc., of Fair Lawn, N.J., USA.

A “high intensity sweetener” as used herein means agents having a sweetness at least 100 times that of sugar (sucrose) on a per weight basis, specifically at least 500 times that of sugar on a per weight basis. In one embodiment the high intensity sweetener is at least 1,000 times that of sugar on a per weight basis, more specifically at least 5,000 times that of sugar on a per weight basis. The high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Any combination comprising two or more high intensity sweetener can be used. One or more of the high intensity sweeteners can further be combined with one or more of the foregoing sweeteners or sweetening agents. The high intensity sweetener can be used in a variety of distinct physical forms, for example those known in the art to provide an initial burst of sweetness and/or a prolonged sensation of sweetness. Without being limited thereto, such physical forms include free forms (e.g., spray dried or powdered), beaded forms, encapsulated forms, and combinations of the foregoing forms.

Without being limited to particular sweetening agents, representative categories and examples include: (1) water-soluble sweetening agents such as dihydrochalcones, monellin, steviosides, Rebaudioside A, Rebaudioside B, Rebaudioside C, glycyrrhizin, dihydroflavenol, and sugar alcohols such as sorbitol, mannitol, maltitol, monatin, and L-aminodicarboxylic acid aminoalkenoic acid ester amides, such as those disclosed in U.S. Pat. No. 4,619,834 to Zanno et al., and combinations thereof; (2) water-soluble artificial sweeteners such as saccharin, soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and combinations thereof; (3) dipeptide based sweeteners, for example the L-aspartic acid derived sweeteners such as L-aspartyl-L-phenylalanine methyl ester (Aspartame) and materials described in U.S. Pat. No. 3,492,131 to Schlatter, L-alpha-aspartyl-N-(2,2,4,4-tetramethyl-3-thietanyl)-D-alaninamide hydrate (Alitame), methyl esters of L-aspartyl-L-phenylglycine and L-aspartyl-L-2,5-dihydrophenylglycine, L-alpha-aspartyl-L-phenylglycine methyl ester, L-alpha-aspartyl-L-2,5-dihydrophenylglycine methyl ester, L-aspartyl-2,5-dihydro-L-phenylalanine; L-alpha-aspartyl-2,5-dihydrophenylalanine methyl ester, L-aspartyl-L-(1-cyclohexen)-alanine, N—(N-(3,3-dimethylbutyl)-L-alpha-aspartyl)-L-phenylalanine methyl ester (Neotame), or a combination thereof; (4) derivatives of water-soluble sweeteners, such as steviosides, Rebaudioside A, Rebaudioside B, Rebaudioside C, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructofuranoside, 4,1′-dichloro-4,1′-dideoxygalactosucrose; 1′,6′-dichloro-1′,6′-dideoxysucrose; 1,6-dichloro-1,6-dideoxy-β-D-fructofuranosyl-4-chloro-4-deoxy-α-D-galactopyranoside; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideox y-beta-D-fructofuranoside, or 4,6,1′,6′-tetrachloro4,6,1′,6′-tetradeoxygalacto-sucrose; 4,6,1′,6′-tetradeoxy-sucrose, and combinations thereof; (5) protein based sweeteners such as thaumatococcous danielli, thaumatin, talin; mogrosides (lo han guo); and combinations thereof; and (6) amino acid based sweeteners.

In some embodiments, the sweeteners include sorbitol, mannitol, aspartame, acesulfame potassium salt, and combinations thereof. The sweeteners can be present in a suitable amount depending upon the desired level of sweetness. In some embodiments the sweeteners are present in an amount of about 35 to about 80 weight percent of the chewing gum composition. Within the range of about 35 to about 80, the amount can be about 45 to about 75 weight percent, specifically the amount can be about 50 to 65 weight percent.

In another preferred embodiment the chewing gum can further include unencapsulated sweeteners. Suitable unencapsulated sweeteners include any of the sweeteners recited herein. In some embodiments, the unencapsulated sweeteners include sugar alcohols, polyols, and mixtures thereof. In some embodiments, the unencapsulated sweeteners include sorbitol, mannitol, and mixtures thereof. In one embodiment, the unencapsulated active ingredients are present in an amount about 5.0 to about 50 weight percent based upon the total weight of the chewing gum composition. In one embodiment, the unencapsulated sweeteners are present in an amount about 9.0 to about 49.0 weight percent based upon the total weight of the chewing gum composition. In one embodiment, the unencapsulated sweeteners are present in an amount about 9.0 to about 39.0 weight percent based upon the total weight of the chewing gum composition. In some embodiments, the unencapsulated sweeteners are present in an amount of about 10.0 to about 35.0 weight percent of the chewing gum composition.

In a chewing gum product, a sweet taste can come from flavorants or flavoring agents, and/or from flavor modulators or potentiators. Flavor modulators can impart a characteristic of their own that complements or negates a characteristic of another component. For example, flavors can be compounded to have additional sweet notes by the inclusion of flavor modulators or potentiators, such as vanilla, vanillin, ethyl maltol, furfural, ethyl propionate, lactones, and combinations thereof. The flavor modulators can be used in the amount about 0.01 to about 30 weight percent of the chewing gum composition depending on the desired intensity of the aromas used. Preferably, the content of the flavor modulators is in the range of about 0.2 to about 3 weight percent of the chewing gum composition.

Flavorants (also known as flavorings, flavors or flavoring agents) that can be used include those artificial and natural flavors known in the art, for example synthetic flavor oils, natural flavoring aromatics and/or oils, oleoresins, extracts derived from plants, leaves, flowers, fruits, and the like, and combinations comprising at least one of the foregoing flavorants. Non-limiting representative flavors include oils such as spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils including lemon, orange, lime, grapefruit, vanilla, fruit essences, including apple, pear, peach, grape, strawberry, raspberry, blackberry, cherry, plum, pineapple, apricot, banana, melon, tropical fruit, mango, mangosteen, pomegranate, papaya, honey lemon, and the like, and combinations thereof. Specific flavorants are mints such as peppermint, spearmint, artificial vanilla, cinnamon derivatives, and various fruit flavors.

Examples of artificial, natural and synthetic fruit flavorings include coconut, coffee, chocolate, vanilla, lemon, grapefruit, orange, lime, yazu, sudachi, menthol, licorice, caramel, honey, peanut, walnut, cashew, hazelnut, almonds, pineapple, strawberry, raspberry, blackberry, tropical fruits, cherries, cinnamon, peppermint, wintergreen, spearmint, eucalyptus, and mint, fruit essence such as from apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya, and the like, and combinations thereof.

Other types of flavorants include various aldehydes and esters such as cinnamyl acetate, cinnamaldehyde, citral diethylacetal, dihydrocarvyl acetate, eugenyl formate, p-methylamisol, acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), 2-dodecenal (citrus, mandarin), and combinations thereof.

Other potential flavors whose release profiles can be managed include a milk flavor, a butter flavor, a cheese flavor, a cream flavor, a yogurt flavor, a vanilla flavor, a tea or coffee flavor, such as a green tea flavor, a oolong tea flavor, a cocoa flavor, a chocolate flavor, a mint flavor, such as peppermint, spearmint, and Japanese mint; spicy flavors, such as asafetida, ajowan, anise, angelica, fennel, allspice, cinnamon, chamomile, mustard, cardamom, caraway, cumin, clove, pepper, coriander, sassafras, savory, Zanthoxyli Fructus, perilla, juniper berry, ginger, star anise, horseradish, thyme, a tarragon, dill, capsicum, nutmeg, basil, marjoram, rosemary, bay leaf, and wasabi; alcoholic flavors, such as wine, whisky, brandy, rum, gin, and liqueur; floral and vegetable flavors, such as onion, garlic, cabbage, carrot, celery, mushroom, and tomato. Commonly used flavorings include mints such as peppermint, menthol, spearmint, artificial vanilla, cinnamon derivatives, and various fruit flavors, whether employed individually or in admixture. Flavors can also provide breath freshening properties, particularly the mint flavors when used in combination with cooling agents. In some embodiments, the composition can further include fruit juices.

The flavoring agents can be used in many distinct physical forms. Such physical forms include liquid and/or dried form. In some embodiments, the flavoring agents can be in free (unencapsulated) forms, spray dried forms, freeze dried forms, powdered forms, beaded forms, encapsulated forms, slices, pieces, and mixtures thereof. When employed in a spray-dried form, suitable drying means such as spray drying a liquid can be used. Alternatively, the flavoring agent can be absorbed onto water soluble materials, such as cellulose, starch, sugar, maltodextrin, gum arabic and so forth or it can be encapsulated. In still other embodiments, the flavoring agent can be adsorbed onto silicas, zeolites, and the like. The particle size of the flavorings can be less than 3 millimeters, less than 2 millimeters or preferably less than 1 millimeter, calculated as the longest dimension of the particle. The natural flavoring agent can have a particle size of about 3 micrometers to about 2 millimeters, specifically about 4 micrometers to about 1 millimeter. The flavorants can be used in the amount about 0.01 to about 30 weight percent of the gum composition depending on the desired intensity of the aromas used. Preferably, the content of the flavorants is in the range of about 0.2 to about 3 weight percent of the gum composition.

Flavor potentiators are materials that intensify, supplement, modify or enhance the taste or aroma perception of an original material without introducing a characteristic taste or aroma perception of their own. In some embodiments, flavor potentiators are designed to intensify, supplement, modify, or enhance the perception of flavor, sweetness, tartness, umami, kokumi, saltiness or a combination thereof. The flavor potentiators can be used in the amount about 0.01 to about 30 weight percent of the gum composition depending on the desired intensity of the aromas used. Preferably, the content of the flavor potentiators is in the range of about 0.2 to about 3 weight percent of the gum composition. Exemplary flavor modulators or potentiators include monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), and combinations thereof. In some embodiments, the flavor modulator or potentiator is selected from sugar acids, sodium chloride, potassium chloride, sodium acid sulfate, and combinations thereof. In other embodiments, the flavor modulator or potentiator is selected from glutamates such as monosodium glutamate, monopotassium glutamate, hydrolyzed vegetable protein, hydrolyzed animal protein, yeast extract, and combinations thereof. Further examples include adenosine monophosphate (AMP), glutathione, and nucleotides such as inosine monophosphate, disodium inosinate, xanthosine monophosphate, guanylate monophosphate, and combinations thereof. Further examples of flavor potentiator compositions that impart kokumi are also included in U.S. Pat. No. 5,679,397 to Kuroda et al.

The amount of flavorants, flavor modulators, and flavor potentiators used herein can be a matter of preference subject to such factors as the type of final comestible product composition, the individual flavor, the confectionary base employed, and the strength of flavor desired. Thus, the amount of flavoring can be varied in order to obtain the result desired in the final product and such variations are within the capabilities of those skilled in the art without the need for undue experimentation.

In some embodiments, the chewing gum can contain aroma agents and/or flavoring agents including natural and synthetic flavorings such as natural vegetable components, flavoring aromatics and/or oils, essential oils, essences, extracts, powders, food-grade acids, oleoresins and extracts derived from plants, leaves, flowers, fruits, and the like, and combinations thereof. The flavorings can be in liquid or powdered form.

In some embodiments, the chewing gum contains aroma agents including natural and synthetic flavorings such as natural vegetable components, flavoring aromatics and/or oils, essential oils, essences, extracts, powders, food-grade acids, oleoresins and extracts derived from plants, leaves, flowers, fruits, and the like, and combinations thereof. The aroma agents can be in liquid or powdered form. In some embodiments, the encapsulated sweetener composition further contains a flavoring, any of the flavoring described herein are suitable for use. The aroma agents and/or flavors can be used in the amount of about 0.01 to about 30 weight percent of the gum composition depending on the desired intensity of the aromas and/or flavors used. Preferably, the content of the aromas and/or flavors is in the range of about 0.2 to about 4 weight percent of the gum composition.

In some embodiments, the chewing gum can also deliver multiple, distinct flavors to the consumer resulting in a flavor-changing gum composition. In one embodiment, the chewing gum composition contains a poly(vinyl acetate) and fatty acid salt encapsulated sweetener composition, as described herein, and further contains at least a first flavor composition and a second flavor composition, wherein the first flavor composition begins to release from the chewing gum when the chewing gum composition is masticated, and the second flavor composition comprising the encapsulated sweetener composition begins to release after the first flavor composition has begun to release. In another embodiment, the chewing gum includes a third flavor composition that begins to release after the second flavor composition.

In other embodiments, the chewing gum composition delivers multiple, distinct flavors such as, for example, sweet flavors, sour flavors, fruit flavors, mint flavors and the like, including any of the flavorings and/or sensates disclosed herein. The sweet and sour flavors can be released in any sequential order or combination. For example, in one embodiment of the gum composition the first flavor composition is a sweet flavor and the second flavor composition is a sour flavor. In another embodiment, the first flavor composition is a sweet flavor, the second flavor composition is a sour flavor, and the third flavor composition is a sweet flavor.

The chewing gum can further include cooling and warming agents. Cooling agents, also known as coolants, are additives that provide a cooling or refreshing effect in the mouth, in the nasal cavity, or on skin. Menthyl-based coolants as used herein include menthol and menthol derivatives. Menthol (also known as 2-(2-propyl)-5-methyl-1-cyclohexanol) is available in artificial form, or naturally from sources such as peppermint oil. Menthol derivatives include menthyl ester-based and menthyl carboxamide-based cooling compounds such as menthyl carboxamide, N-ethyl-p-menthane carboxamide, monomenthyl succinate, monomenthyl methyl succinate, monomenthyl glutarate, menthyl 2-pyrrolidone-5-carboxylate, monomenthyl 3-methyl maleate, menthyl acetate, menthyl lactate, menthyl salicylate, 2-isopropanyl-5-methylcyclohexanol, 3-L-menthoxypropane-1,2-diol, menthane, menthone, menthone ketals, menthone glycerol ketals, menthyl glutarate esters, N-ethyl-p-menthane-3-carboxamide (WS-3), and combinations thereof. Additional menthyl-based coolants, specifically menthylcarboxamides, are described in U.S. Pat. No. 7,923,577 to Bardsley et al.

Other cooling agents that can be used in combination with or in the absence of the menthyl-based coolants include, for example 2-mercapto-cyclo-decanone, hydroxycarboxylic acids with 2 to 6 carbon atoms, xylitol, erythritol, alpha-dimethyl succinate, menthyl lactate, acyclic carboxamides such as N-2,3-trimethyl-2-isopropyl butanamide, and combinations thereof. Additional cooling agents include the 1-tert-butylcyclohexanecarboxamides described in U.S. Patent Application Publication Nos. US 2011/0070171 A1 and US 2011/0070329 A1 of Kazimierski et al.

Cooling compositions comprising a primary cooling compound, a secondary cooling compound, and an ingestible non-polar solvent are described in U.S. Patent Application Publication No. US 2011/0091531 A1 of Furrer et al. The cooling agents can be present in a suitable amount depending upon the desired level of cooling intensity. In some embodiments, the cooling agents are present in an amount of about 0.01 to about 1.5 weight percent of the chewing gum composition. Within the range of about 0.01 to about 1.5 weight percent, the cooling agents can be about 0.05 to about 1.25 weight percent, specifically the cooling agents can be about 0.1 to 1 weight percent.

Warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming compounds included are vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-amino ether, vanillyl alcohol isoamylether, vanillyl alcohol n-hexylether, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerin, and combinations thereof. The warming agents can be present in a suitable amount depending upon the desired level of warming intensity. In some embodiments, the warming agents are present in an amount of about 0.01 to about 1.5 weight percent of the chewing gum composition. Within the range of about 0.01 to about 1.5 weight percent, the warming agents can be about 0.05 to about 1.25 weight percent, specifically the warming agents can be about 0.1 to 1 weight percent.

In some embodiments, a tingling sensation can be provided. Tingling agents include jambu, and alkylamides extracted from materials such as jambu or sanshool. Tingling agents can be present in a suitable amount depending upon the desired level of intensity. In some embodiments, the tingling agents are present in an amount of about 0.01 to about 2 weight percent of the chewing gum composition. Within the range of about 0.01 to about 2 weight percent, the tingling agents can be about 0.05 to about 1.25 weight percent; specifically, the tingling agents can be about 0.1 to 1 weight percent.

Additionally, a sensation can be created due to effervescence. Such effervescence is created by combining a basic material with an acidic material. In some embodiments, the basic material can include alkali metal carbonates, alkali metal bicarbonates, alkaline earth metal carbonates, alkaline earth metal bicarbonates, and combinations thereof. In some embodiments, the acidic material can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid, and combinations thereof. Effervescing agents can be present in a suitable amount depending upon the desired level of intensity. In some embodiments, the effervescing agents are present in an amount of about 0.01 to about 2 weight percent of the chewing gum composition. Within the range of about 0.01 to about 2 weight percent, the effervescing agents can be about 0.05 to about 1.25 weight percent; specifically, the effervescing agents can be about 0.1 to 1 weight percent.

Coloring agents (colorants, colorings) can be used in amounts effective to produce a desired color for the comestible. Suitable coloring agents include pigments, which can be incorporated in amounts up to about 6 weight percent of the chewing gum composition. For example, titanium dioxide can be incorporated in amounts up to about 2 weight percent, and specifically less than about 1 weight percent by weight of the chewing gum composition. Suitable coloring agents also include natural food colors and dyes suitable for food, drug, and cosmetic applications.

Suitable colors include annatto extract (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120), carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminum (E173), silver (E174), gold (E175), pigment rubine/litholrubine BK (E180), calcium carbonate (E170), carbon black (E153), black PN/brilliant black BN (E151), green S/acid brilliant green BS (E142), FD&C aluminum lakes, and combinations thereof.

Exemplary breath fresheners that can be used in the chewing gum include zinc citrate, zinc acetate, zinc fluoride, zinc ammonium sulfate, zinc bromide, zinc iodide, zinc chloride, zinc nitrate, zinc fluorosilicate, zinc gluconate, zinc tartrate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based material, carbon-based material, enzymes such as laccase, or a mixture comprising at least one of the foregoing. Breath fresheners can include essential oils as well as various aldehydes and alcohols. Essential oils used as breath fresheners can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, orange, or a combination thereof. Aldehydes such as cinnamic aldehyde and salicylaldehyde can be used. Additionally, chemicals such as menthol, carvone, iso-garrigol, and anethole can function as breath fresheners. The breath fresheners can be present in a suitable amount depending upon the desired level of intensity. In some embodiments, the breath fresheners are present in an amount of about 0.01 to about 2 weight percent of the chewing gum composition. Within the range of about 0.01 to about 2 weight percent, the breath fresheners can be about 0.05 to about 1.25 weight percent; specifically, the breath fresheners can be about 0.1 to 1 weight percent.

Exemplary mouth moisteners include saliva stimulators such as acids and salts including acetic acid, adipic acid, ascorbic acid, butyric acid, citric acid, formic acid, fumaric acid, glyconic acid, lactic acid, phosphoric acid, malic acid, oxalic acid, succinic acid, and tartaric acid. Mouth moisteners can include hydrocolloid materials that hydrate and can adhere to oral surface to provide a sensation of mouth moistening. Hydrocolloid materials can include naturally occurring materials such as plant exudates, seed gums, and seaweed extracts or they can be chemically modified materials such as cellulose, starch, or natural gum derivatives. Furthermore, hydrocolloid materials can include pectin, gum arabic, acacia gum, alginates, agar, carrageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, and bacterial gums. Mouth moisteners can include modified natural gums such as propylene glycol alginate, carboxymethyl locust bean gum, low methoxyl pectin, or a combination thereof. Modified celluloses can be included, such as microcrystalline cellulose, carboxymethylcellulose (CMC), methylcellulose (MC), hydroxypropylmethylcellulose (HPMC), hydroxypropylcellulose (HPC), or a combination thereof. The mouth moisteners can be present in a suitable amount depending upon the desired level of intensity. In some embodiments, the mouth moisteners are present in an amount of about 0.01 to about 2 weight percent of the chewing gum composition. Within the range of about 0.01 to about 2 weight percent, the mouth moisteners can be about 0.05 to about 1.25 weight percent; specifically, the mouth moisteners can be about 0.1 to 1 weight percent.

Similarly, humectants, which can provide a perception of mouth hydration, can be included. Such humectants can include glycerol, sorbitol, polyethylene glycol, erythritol, xylitol, or a combination thereof. Additionally, in some embodiments, fats can provide a perception of mouth moistening. Such fats can include medium chain triglycerides, vegetable oils, fish oils, mineral oils, or a combination thereof. The humectants can be present in a suitable amount depending upon the desired level of intensity. In some embodiments, the humectants are present in an amount of about 0.01 to about 2 weight percent of the chewing gum composition. Within the range of about 0.01 to about 2 weight percent, the humectants can be about 0.05 to about 1.25 weight percent; specifically, the humectants can be about 0.1 to 1 weight percent.

Suitable food-grade acids include acetic acid, citric acid, fumaric acid, hydrochloric acid, lactic acid and nitric acid as well as sodium citrate, sodium bicarbonate, sodium carbonate, sodium or potassium phosphate, magnesium oxide, potassium metaphosphate, sodium acetate, and combinations thereof. The acidulants can be present in a suitable amount depending upon the desired level of intensity. In some embodiments, the acidulants are present in an amount of about 0.1 to about 3 weight percent of the chewing gum composition. Within the range of about 0.1 to about 3 weight percent, the acidulants can be about 0.5 to about 2.5 weight percent; specifically, the humectants can be about 0.75 to 2 weight percent.

In a preferred embodiment the chewing gum can further include unencapsulated food-grade acids. Suitable unencapsulated acids include, for example, adipic acid, ascorbic acid, aspartic acid, benzoic acid, citric acid, fumaric acid, glutamic acid, maleic acid, malic acid, oxalic acid, phosphoric acid, sorbic acid, succinic acid, tartaric acid, and mixtures thereof. In some embodiments, the unencapsulated acids include citric acid, malic acid, and mixtures thereof. In one embodiment, the unencapsulated food-grade acids are present in an amount about 0.1 to about 2.0 weight percent based upon the total weight of the chewing gum composition. In one embodiment, the unencapsulated food-grade acids are present in an amount about 0.1 to about 2.0 weight percent based upon the total weight of the chewing gum composition. In some embodiments, the unencapsulated food-grade acids are present in an amount of about 0.25 to about 1.5 weight percent, more specifically about 0.5 to about 1.0 weight percent of the chewing gum composition.

Exemplary buffering agents include sodium bicarbonate, sodium phosphate, sodium hydroxide, ammonium hydroxide, potassium hydroxide, sodium stannate, triethanolamine, citric acid, hydrochloric acid, sodium citrate, and combinations thereof. The buffering agents can be present in a suitable amount depending upon the desired level of intensity. In some embodiments, the buffering agents are present in an amount of about 0.01 to about 2 weight percent of the chewing gum composition. Within the range of about 0.01 to about 2 weight percent, the buffering agents can be about 0.05 to about 1.25 weight percent; specifically, the buffering agents can be about 0.1 to 1 weight percent.

Suitable oral care agents include breath fresheners, tooth whiteners, antimicrobial agents, tooth mineralizers, tooth decay inhibitors, topical anesthetics, mucoprotectants, stain removers, oral cleaning agents, bleaching agents, desensitizing agents, dental remineralization agents, antibacterial agents, anticaries agents, plaque acid buffering agents, surfactants and anticalculus agents, and combinations thereof. Examples of such ingredients include hydrolytic agents including proteolytic enzymes, abrasives such as hydrated silica, calcium carbonate, sodium bicarbonate and alumina, other active stain-removing components such as surface-active agents, including anionic surfactants such as sodium stearate, sodium palminate, sulfated butyl oleate, sodium oleate, salts of fumaric acid, glycerol, hydroxylated lecithin, sodium lauryl sulfate and chelators such as polyphosphates, which are typically employed as tartar control ingredients. Oral care ingredients can also include tetrasodium pyrophosphate, sodium bicarbonate, sodium acid pyrophosphate, sodium tripolyphosphate, xylitol, sodium hexametaphosphate, and combinations thereof.

In addition, suitable oral care agents include peroxides such as carbamide peroxide, calcium peroxide, magnesium peroxide, sodium peroxide, hydrogen peroxide, and peroxydiphosphate. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples can include papaine, krillase, pepsin, trypsin, lysozyme, dextranase, mutanase, glycoamylase, amylase, glucose oxidase, and combinations thereof.

Suitable oral care agents include surfactants that achieve increased prophylactic action and render the oral care ingredients more cosmetically acceptable. Surfactants used as oral care agents include detersive materials that impart to the composition detersive and foaming properties. Suitable surfactants include sodium stearate, sodium ricinoleate, sodium lauryl sulfate, water-soluble salts of higher fatty acid monoglyceride monosulfates, such as the sodium salt of the monosulfated monoglyceride of hydgrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like. Examples of the last mentioned amides are N-lauroyl sarcosine, and the sodium, potassium, and ethanolammonium salts of N-lauroyl sarcosine, N-myristoyl sarcosine, or N-palmitoyl sarcosine.

In addition to surfactants, oral care ingredients can include antibacterial agents such as triclosan, chlorhexidine, zinc citrate, silver nitrate, copper, limonene, cetyl pyridinium chloride, and combinations thereof.

Anticaries agents include fluoride ion sources, such as sodium fluoride, potassium fluoride, sodium fluorosilicate, ammonium fluorosilicate, potassium fluoride, sodium monofluorophosphate, stannous fluoride, potassium stannous fluoride, sodium hexafluorostannate, stannous chloro fluoride, and combinations thereof.

Further examples of oral care agents are included in U.S. Pat. No. 5,227,154 to Reynolds, U.S. Pat. No. 5,378,131 to Greenberg, and U.S. Pat. No. 6,685,916 to Holme et al. Oral care agents can be present in a suitable amount depending upon the desired level of care. In some embodiments, the oral care agents are present in an amount of about 0.01 to about 2 weight percent of the chewing gum composition. Within the range of about 0.01 to about 2 weight percent, the oral care agents can be about 0.05 to about 1.25 weight percent; specifically, the oral care agents can be about 0.1 to 1 weight percent.

Throat care or throat-soothing ingredients include analgesics, antihistamines, anesthetics, demulcents, mucolytics, expectorants, antitussives, antiseptics, and combinations thereof. In some embodiments, a throat soothing agent such as honey, propolis, aloe vera, glycerin, menthol, or a combination thereof is employed. Throat care agents can be present in a suitable amount depending upon the desired level of care. In some embodiments, the throat care agents are present in an amount of about 0.01 to about 2 weight percent of the chewing gum composition. Within the range of about 0.01 to about 2 weight percent, the throat care agents can be about 0.05 to about 1.25 weight percent; specifically, the throat care agents can be about 0.1 to 1 weight percent

Medicaments can be included in the chewing gum product. Non-limiting illustrative categories and specific examples include antihistamines, decongestants (sympathomimetics), antitussives (cough suppressants), expectorants, anesthetics, analgesics, demulcents, antibacterial agents, antiviral agents, anti-inflammatories, antacids, antifungal agents, chemotherapeutics, diuretics, psychotherapeutic agents, homeopathic agents, anticholinergics, throat-soothing agents, antinauseants, cardiovascular agents, various alkaloids, laxatives, appetite suppressants, ACE-inhibitors, anti-asthmatics, anti-cholesterolemics, anti-depressants, anti-diarrhea preparations, anti-hypertensives, anti-lipid agents, acne drugs, amino acid preparations, anti-uricemic drugs, anabolic preparations, appetite stimulants, bone metabolism regulators, contraceptives, endometriosis management agents, enzymes, erectile dysfunction therapies such as sildenafil citrate, fertility agents, gastrointestinal agents, homeopathic remedies, hormones, motion sickness treatments, muscle relaxants, osteoporosis preparations, oxytocics, parasympatholytics, parasympathomimetics, prostaglandins, respiratory agents, sedatives, smoking cessation aids such as bromocryptine or nicotine, tremor preparations, urinary tract agents, anti-ulcer agents, anti-emetics, hyper- and hypo-glycemic agents, thyroid and anti-thyroid preparations, terine relaxants, erythropoietic drugs, mucolytics, DNA and genetic modifying drugs, health-promoting agents such as probiotics, and nutritional supplements, including nutraceuticals, micronutrients, vitamins and co-enzymes. The pharmaceutically acceptable salts and prodrugs of the medicaments are also included unless specified otherwise. Some of these medicaments can serve more than one purpose. Combinations of the foregoing types of optional medicaments can be used. Two or more medicaments that have activity against the same or different symptoms can be used together in a combination.

Medicaments for the treatment of a cough, or a cold or flu symptom include elements, compounds or materials, alone or in combination, that have been used for, or have been shown to be useful for, the amelioration of at least one symptom commonly associated with cough, colds, or influenza. It is to be understood that a “medicament for the treatment of a cough, or a cold or flu symptom” includes medicaments that are also useful for the treatment of cold-like or flu-like symptoms arising from other sources, such as allergies, adverse environmental conditions, and the like. Cold, cold-like, flu, and flu-like symptoms as used herein include cough, coryza, nasal congestion, upper respiratory infections, allergic rhinitis, otitis, sinusitis, sneezing, and the discomfort, pain, fever and general malaise associated with colds, flu, allergies, adverse environmental conditions, and the like.

Examples of general categories of medicaments for the treatment of a cough, or a cold or flu symptom include antihistamines, decongestants (sympathomimetics), antitussives (cough suppressants), anti-inflammatories, homeopathic agents, expectorants, anesthetics, demulcents, analgesics, anticholinergics, throat-soothing agents, antibacterial agents, and antiviral agents. Some of these medicaments can serve more than one purpose. The pharmaceutically acceptable salts and prodrugs of the medicaments are also included unless specified otherwise. Two or more medicaments that have activity against the same or different symptoms of colds or coughs can be used together in a combination.

Exemplary antihistamines include azatadine, bromodiphenhydramine, brompheniramine, brompheniramine maleate, carbinoxamine, carbinoxamine maleate, cimetidine, chlorpheniramine, chlorpheniramine maleate, dexchlorpheniramine, diphenhydramine, diphenhydramine hydrochloride, doxylamine, phenindamine, pheniramine, phenyltoloxamine, pyrilamine, promethazine, triprolidine, loratadine, ranitidine, chlorcyclizine, terfenadine, clemastine fumarate, dimenhydrinate, prilamine maleate, tripelennamine hydrochloride, tripelennamine citrate, hydroxyzine pamoate, hydroxyzine hydrochloride, cyclizine lactate, cyclizine hydrochloride, meclizine hydrochloride, acrivastine, cetirizine hydrochloride, astemizole, levocabastine hydrochloride, cetirzine, and combinations thereof.

Exemplary decongestants include agents such as levopropoxyphene napsylate, noscapine, carbetapentane, caramiphen, chlophedianol, pseudoephedrine hydrochloride, phenylephrine, phenylpropanolamine, diphenhydramine, glaucine, pholcodine, benzonatate, ephedrine, ephinephrine, levodesoxyephedrine, oxymetazoline, naphazo line, propylhexedrine, xylometazoline, and combinations thereof.

Antitussives help relieve coughing. Examples of antitussives include codeine, dihydrocodeine, hydrocodone and hydromorphone, carbetapentane, caramiphen, hydrocodone bitartrate, chlorphedianol, noscarpine, dextromethorphan, and combinations thereof.

Expectorants include guaifenesin, aniseed, blood root, coltsfoot, elderflower, golden seal, grindelia, hyssop, lungwort, mullein, senega, thuja, thyme, vervain, glyceryl guaiacolate, terpin hydrate, N-acetylcysteine, bromhexine, ambroxol, domiodol, 3-iodo-1,2-propanediol and wild cherry, ammonium chloride, calcium iodide, iodinated glycerol, potassium guaiacolsulfonate, potassium iodide, sodium citrate, and combinations thereof.

Anaesthetics include etomidate, ketamine, propofol, and benodiazapines (e.g., chlordiazepoxide, diazepam, clorezepate, halazepam, flurazepam, quazepam, estazolam, triazolam, alprozolm, midazolam, temazepam, oxazepam, lorazepam), benzocaine, dyclonine, bupivacaine, etidocaine, lidocaine, mepivacaine, promoxine, prilocaine, procaine, proparcaine, ropivacaine, tetracaine, and combinations thereof. Other useful agents can include amobartital, aprobarbital, butabarbital, butalbital mephobarbital, methohexital, pentobarbital, phenobarbital, secobarbital, thiopental, paral, chloral hydrate, ethchlorvynol, clutethimide, methprylon, ethinamate, meprobamate, and combinations thereof.

Analgesics include opioids such as morphine, mepidine, dentanyl, sufentranil, alfentanil, aspirin, salicylamide, sodium salicylate, acetaminophen, ibuprofen, indomethacine, naproxen, atrin, isocome, midrin, axotal, firinal, phrenilin, ergot and ergot derivatives (wigraine, cafergot, ergostat, ergomar, dihydroergotamine), imitrex, and combinations thereof.

Anticholinergics include homatropine, atropine, scopolamine hydrogen bromide, L-hyoscyamine, L-alkaloids of belladonna, tincture of belladonna alkaloids, homatropine hydrogen bromide, homatropine methylbromide, methscopolamine, anisotropine, anisotropine with phenobarbital, clindinium, glycopyrrolate, hexocyclim, isopropamide, mepenzolate, methantheline, oxyphencyclimine, propantheline, tridihexethyl, dicyclomine, scopolamine, atropine, dicyclomine, flavoxate, ipratropium, oxybutynin, pirenzepine, tiotropium, tolterodine, tropicamide, trimethaphan, atracurium, doxacurium, mivacurium, pancuronium, tubocurarine, vecuronium, suxamethonium chloride, and combinations thereof.

Demulcents include coltsfoot, comfrey, corn silk, couchgrass, flaxseed, irish moss, lungwort, liquorice, mallow, marshmallow, mullein, oatmeal, parsley piert, slippery elm, and combinations thereof.

Antibacterial agents include those within the antibiotic classes of aminoglycosides, cephalosporins, macrolides, penicillins, quinolones, sulfonamides, and tetracyclines. Specific exemplary antibiotic agents include naficillin, oxacillin, vancomycin, clindamycin, erythromycin, trimethoprim-sulphamethoxazole, rifampin, ciprofloxacin, broad spectrum penicillin, amoxicillin, gentamicin, ceftriazoxone, cefotaxime, chloramphenicol, clavunate, sulbactam, probenecid, doxycycline, spectinomycin, cefixime, penicillin G, minocycline, β-lactamase inhibitors; meziocillin, piperacillin, aztreonam, norfloxacin, trimethoprim, ceftazidime, dapsone, neomycin, azithromycin, clarithromycin, amoxicillin, ciprofloxacin, and vancomycin.

Antiviral agents specifically or generally modulate the biological activity of viruses such as picornavirus, influenza virus, herpes viruses, herpes simplex, herpes zoster, enteroviruses, varicella and rhinovirus, which are associated with the common cold. Exemplary antiviral agents include acyclovir, trifluridine, idoxorudine, foscarnet, ganciclovir, zidovudine, dideoxycytosine, dideoxyinosine, dipyridamole, stavudine, cidofovir, famciclovir, valaciclovir, valganciclovir, acyclovir, didanosine, zalcitabine, rifimantadine, saquinavir, indinavir, ritonavir, ribavarin, nelfinavir, adefovir, nevirapine, delavirdine, efavirenz, abacavir, amantadine, emtricitabine, entecavir, tenofovir, zanamivir, oseltamivir, ICI 130,685, impulsin, pleconaril, penciclovir, vidarabine, cytokines, and combinations thereof.

Anti-inflammatories include salicylic acid derivatives including aspirin, paraminophenol derivatives including acetaminophen, indole and indene acetic acids including indomethacin, sulindac and etodalac, heteroaryl acetic acids including tolmetin diclofenac and ketorolac, aryl propionic acid derivatives including ibuprofen, naproxen, ketoprofen, fenopren, ketorlac, carprofen, oxaprozine, anthranilic acids including mefenamic acid, meclofenamic acid, and enolic acids including piroxicam, tenoxicam, phenylbutazone and oxyphenthatrazone.

Antacids include cimetidine, ranitidine, nizatidine, famotidine, omeprazole, bismuth antacids, metronidazole antacids, tetracycline antacids, clarthromycin antacids, hydroxides of aluminum, magnesium, sodium bicarbonates, calcium bicarbonate and other carbonates, silicates, phosphates, and combinations thereof.

Antifungal agents include, for example, ketoconazole, fluconazole, nystatin, itraconazole, clomitrazole, natamycin, econazole, isoconazole, oxiconazole, thiabendazole, tiaconazole, voriconazole, terbinafine, amorolfine, micfungin, amphotericin B, and combinations thereof.

Chemotherapeutics agents include cisplatin (CDDP), procarbazine, mechlorethamine, cyclophosphamide, camptothecin, ifosfamide, melphalan, chlorambucil, bisulfan, nitrosurea, dactinomycin, daunorubicin, doxorubicin, bleomycin, plicomycin, mitomycin, etoposide (VP16), tamoxifen, taxol, transplatinum, 5-fluorouracil, vincristin, vinblastin and methotrexate and analogs or derivative variants thereof, and combinations thereof.

Diuretics include but are not limited to acetazolamide, dichlorphenamide, methazolamide, furosemide, bumetanide, ethacrynic acid torseimde, azosemide, muzolimine, piretanide, tripamide, bendroflumethiazide, benzthiazide, chlorothiazide, hydrochlorothiazide, hydroflumethiazide, methyclothiazide, polythiazide, trichlormethiazide, indapamide, metolazone, quinethazone, amiloride, triamterene, sprionolactone, canrenone, potassium canrenoate, and combinations thereof.

Psychotherapeutic agents include thorazine, serentil, mellaril, millazine, tindal, permitil, prolixin, trilafon, stelazine, suprazine, taractan, navan, clozaril, haldol, halperon, loxitane, moban, orap, risperdal, alprazolam, chlordiaepoxide, clonezepam, clorezepate, diazepam, halazepam, lorazepam, oxazepam, prazepam, buspirone, elvavil, anafranil, adapin, sinequan, tofranil, surmontil, asendin, norpramin, pertofrane, ludiomil, pamelor, vivactil, prozac, luvox, paxil, zoloft, effexor, welibutrin, serzone, desyrel, nardil, parnate, eldepryl, and combinations thereof.

Appetite suppressants include benzphetamine, diethylpropion, mazindol, phendimetrazine, phentermine, hoodia, ephedra, and caffeine. Additional appetite suppressant are commercially under the following trade names: Adipex, Adipost, Bontril PDM, Bontril Slow Release, Didrex, Fastin, Ionamin, Mazanor, Melfiat, Obenix, Phendiet, Phendiet-105, Phentercot, Phentride, Plegine, Prelu-2, Pro-Fast, PT 105, Sanorex, Tenuate, Sanorex, Tenuate, Tenuate Dospan, Tepanil Ten-Tab, Teramine, Zantryl and combinations thereof.

Nutraceuticals and micronutrients include herbs and botanicals such as aloe, bilberry, bloodroot, calendula, capsicum, chamomile, cat's claw, echinacea, garlic, ginger, ginko, goldenseal, various ginseng, green tea, golden seal, guarana, kava kava, lutein, nettle, passionflower, rosemary, saw palmetto, St. John's wort, thyme, valerian, and combinations thereof. Also included are mineral supplements such as calcium, copper, iodine, iron, magnesium, manganese, molybdenum, phosphorous, zinc, selenium, and combinations thereof. Other nutraceuticals that can be added include fructo-oligosaccharides, glucosamine, grapeseed extract, cola extract, guarana, ephedra, inulin, phytosterols, phytochemicals, catechins, epicatechin, epicatechin gallate, epigallocatechin, epigallocatechin gallate, isoflavones, lecithin, lycopene, oligofructose, polyphenols, flavanoids, flavanols, flavonols, and psyllium as well as weight loss agents such as chromium picolinate and phenylpropanolamine. Vitamins and co-enzymes include water or fat-soluble vitamins such as thiamin, riboflavin, nicotinic acid, pyridoxine, pantothenic acid, biotin, folic acid, flavin, choline, inositol and paraminobenzoic acid, carnitine, vitamin C, vitamin D and its analogs, vitamin A and the carotenoids, retinoic acid, vitamin E, vitamin K, vitamin B₆, vitamin B₁₂, and combinations thereof. Combinations comprising at least one of the foregoing nutraceuticals can be used.

Specific optional, additional medicaments that can be used include health-promoting agents such as probiotics, caffeine, cimetidine, ranitidine, famotidine, omeprazole, dyclonine, nicotine, and combinations thereof.

The medicaments can be present in a suitable amount depending upon the suitable level of dosage for the desired purpose. In some embodiments, the medicaments are present in an amount of about 0.01 to about 2 weight percent of the chewing gum composition. Within the range of about 0.01 to about 2 weight percent, the medicaments can be about 0.05 to about 1.25 weight percent; specifically, the medicaments can be about 0.1 to 1 weight percent.

Anti-oxidants include natural and artificial anti-oxidants like beta-carotenes, acidulants e.g. Vitamin C, propylgallate, butyl hydroxyanisole, butylated hydroxytoluene, Vitamin E, Carnosic acid, Rosmanol, rosmaridiphenol, and the likes. The anti-oxidants can be present in a suitable amount depending upon the desired purpose. In some embodiments, the anti-oxidants are present in an amount of about 0.01 to about 2 weight percent of the chewing gum composition. Within the range of about 0.01 to about 2 weight percent, the anti-oxidants can be about 0.05 to about 1.25 weight percent; specifically, the anti-oxidants can be about 0.1 to 1 weight percent.

Preservatives include any natural and synthetic preservatives that improve shelf life of a chewing gum product. Suitable preservatives include propanoic acid, benzoic acid, and sorbic acid.

Additional bulking agents (carriers, extenders) suitable for use include sweetening agents such as monosaccharides, disaccharides, polysaccharides, sugar alcohols, polydextrose, maltodextrins, and combinations thereof; and minerals, such as calcium carbonate, talc, titanium dioxide, dicalcium phosphate, silica, and combinations thereof. Bulking agents can be used in amounts up to about 90 weight percent of the chewing gum composition, specifically about 40 to about 70 weight percent of the chewing gum composition, more specifically about 50 to about 65 weight percent of the chewing gum composition.

Suitable emulsifiers include distilled monoglycerides, acetic acid esters of mono and diglycerides, citric acid esters of mono and diglycerides, lactic acid esters of mono and diglycerides, mono and diglycerides, polyglycerol esters of fatty acids, ceteareth-20, polyglycerol polyricinoleate, propylene glycol esters of fatty acids, polyglyceryl laurate, glyceryl cocoate, gum arabic, acacia gum, sorbitan monostearates, sorbitan tristearates, sorbitan monolaurate, sorbitan monooleate, sodium stearoyl lactylates, calcium stearoyl lactylates, diacetyl tartaric acid esters of mono- and diglycerides, glyceryl tricaprylate-caprate/medium chain triglycerides, glyceryl dioleate, glyceryl oleate, glyceryl lacto esters of fatty acids, glyceryl lacto palmitate, glyceryl stearate, glyceryl laurate, glyceryl dilaurate, glyceryl monoricinoleate, triglyceryl monostearate, hexaglyceryl distearate, decaglyceryl monostearate, decaglyceryl dipalmitate, decaglyceryl monooleate, polyglyceryl 10 hexaoleate, medium chain triglycerides, caprylic/capric triglyceride, propylene glycol monostearate, polysorbate 20, polysorbate 40, polysorbate 60, polysorbate 80, polysorbate 65, hexylglyceryl distearate, triglyceryl monostearate, the poly(oxyethylene) sorbitan fatty acid esters sold under the trade name TWEEN, the sorbitan fatty acid esters sold under the trade name SPAN, stearoyl lactylates, calcium stearoyl-2-lactylate, sodium stearoyl-2-lactylate lecithin, ammonium phosphatide, sucrose esters of fatty acids, sucroglycerides, propane-1,2-diol esters of fatty acids, and combinations comprising at least one of the foregoing.

Suitable thickening agents include cellulose ethers (e.g., hydroxyethylcellulose, hydroxypropylmethylcellulose, or hydroxypropylcellulose), methylcellulose, carboxymethylcellulose, and combinations thereof. Additional polymers useful as thickeners include the acrylic acid polymers and copolymer sold under the trade name CARBOMER; poly(vinyl pyrrolidone); poly(vinyl alcohol); sodium alginate; polyethylene glycol; natural gums like xanthan gum, tragacantha, guar gum, acacia gum, arabic gum; water-dispersible polyacrylates like poly(acrylic acid); methyl methacrylate copolymers; carboxyvinyl copolymers; and combinations thereof.

The relative amounts of each of the components of the chewing gum composition will depend on the identity of the component, as well as the desired flavor, and are readily determined by one of ordinary skill in the art.

The gum compositions of the disclosed herein can be coated or uncoated, and be in the form of slabs, sticks, pellets, balls, and the like. The composition of the different forms of the gum compositions will be similar but can vary with regard to the ratio of the ingredients. For example, coated gum compositions can contain a lower percentage of softeners. Pellets and balls can have a chewing gum core, which has been coated with either a sugar solution or a sugarless solution to create the hard shell. Slabs and sticks are usually formulated to be softer in texture than the chewing gum core. In some cases, a hydroxy fatty acid salt or other surfactants can have a softening effect on the gum base. In order to adjust for any potential undesirable softening effect that the surfactants can have on the gum base, it can be beneficial to formulate a slab or stick gum having a firmer texture than usual (i.e., use less conventional softener than is typically employed).

Center-filled gum is another common gum form. The gum portion has a similar composition and mode of manufacture to that described above. However, the center-fill is typically an aqueous liquid or gel, which is injected into the center of the gum during processing. The encapsulated sweetener composition can, optionally, be incorporated into the center-fill during manufacture of the fill, incorporated directly into the chewing gum portion of the total gum composition, or incorporated into both the center-fill and the chewing gum portion. The center-filled gum can also be optionally coated and can be prepared in various forms, such as in the form of a lollipop.

This disclosure further comprises methods of preparing an encapsulated oil-soluble flavoring agent composition and a chewing gum containing the same. Some embodiments include a method for preparing the gum compositions, including both chewing gum and bubble gum compositions. These chewing gum compositions can be prepared using any standard techniques and equipment known to those skilled in the art. The apparatus useful in accordance with some embodiments includes mixing and heating apparatus that are well known in the chewing gum manufacturing arts, and therefore the selection of the specific apparatus will be apparent to the artisan.

In some embodiments, gum pieces can be coated with an aqueous coating composition, which can be applied by any method known in the art. The coating composition can be present in an amount of about 10 to about 50 weight percent of the total chewing gum piece. Within the rage of about 10 to about 50 weight percent, the coating composition amount can be about 20 to about 40 weight percent, specifically about 25 to 35 weight percent of the total chewing gum piece.

The outer coating can be hard or crunchy. In some embodiments, the outer coating includes sorbitol, maltitol, xylitol, isomalt, or another crystallizable polyol; sucrose can also be used. Flavorants can also be added to yield unique product characteristics.

The coating, if present, can include several opaque layers, such that the chewing gum composition is not visible through the coating itself, which can optionally be covered with a further one or more transparent layers for aesthetic, textural and protective purposes. The outer coating can also contain small amounts of water and gum arabic. The coating can be further coated with wax. The coating can be applied in a conventional manner by successive applications of a coating solution, with drying in between each coat. As the coating dries, it usually becomes opaque and is usually white, though other colorants can be added. A polyol coating can be further coated with wax. The coating can further include colored flakes or speckles.

If the composition comprises a coating, it is possible that one or more of the above-mentioned active ingredients can be dispersed throughout the coating. This may be preferred if one or more of the active ingredients is incompatible in a single phase composition with another of the actives.

The coating can be formulated to assist with increasing the thermal stability of the gum piece and preventing leaking of a liquid fill if the gum product is a center-filled gum. In some embodiments, the coating can include a gelatin composition. The gelatin composition can be added as a 40 weight percent solution and can be present in the coating composition about 5 to about 10 weight percent of the coating composition, and more specifically about 7 to about 8 weight percent of the coating solution. The gel strength of the gelatin can be about 100 bloom to about 300 bloom.

Additives, such as physiological coolants, throat-soothing agents, spices, warming agents, oral care agents, medicaments, vitamins, caffeine, and conventional additives can be included in any or all portions of the chewing gum composition. Such components can be used in amounts sufficient to achieve their intended effects.

The foregoing and other embodiments are further illustrated by the following examples, which are not intended to limit the effective scope of the claims. All parts and percentages in the examples and throughout the specification and claims are by weight of the final composition unless otherwise specified.

### Example 1

This Example describes the process of encapsulation of the model flavor blend containing polyvinyl acetate (PVAC) and ester gum as vapor suppressant agents and using dewatered sodium caseinate precipitate powder as the protein matrix.

In a large beaker, 415 g of sodium caseinate powder was hydrated in 4045 g of DI water by slowly adding the protein powder with continuous overhead low shear mixing. After all of the powder was incorporated, the solution was allowed to hydrate for 30 minutes. Then 300 g of a fruit type Flavor Blend was added slowly to the protein solution under gentle mixing to prepare a coarse emulsion (see preparation of flavor blend below). The coarse emulsion was passed through a two stage high pressure homogenizer to reduce oil droplets to below about 1 micron. Homogenization was carried for one pass at 500 and 5000 psi. Fine emulsion was collected back and was mixed with an overhead mixer. With varying overhead mixing rate, 12% citric acid was added slowly for titrating the pH to the isoelectric point of 4.5. When solution reached the target pH, the protein precipitated out in a particulate form with active flavor oil entrapped within it. Mixing was continued for another 20-30 minutes. De-watering was achieved by filtering under pressure in a filter bag at 40 PSI. When most of the liquid was removed, the filter cake was coarse ground in a food processor. The coarse ground material was then dried in a fluid bed at 60° C. inlet air temperature (product temperature was at around 40-50° C.). Drying continues until moisture was below 5% (3-5%). Dry powder was fine ground and then sifted. The desired fraction of 75-250 um particles was collected for further evaluation.

A commercial cherry/peach fruit flavor blend was mixed with Ester Gum, and polyvinyl acetate (PVAC) (B1.5) in the following weight percentages—66% flavor blend, 17% PVAC (B1.5), and 17% Ester gum.

Example 2, GA Type: This Example demonstrate the preparation of microcapsules using caseinate and shellac combination using flavor blend as above except with MCT as a diluent instead of PVAC and Ester Gum.

Procedure: same as in Example #1 except to the same amount of water, 207.5 g of sodium caseinate was hydrated first, and then 207.5 g of 25% shellac solution was added to the caseinate solution prior to adding flavor blend 2 (same as flavor blend 1 except the PVAC and Ester gum were replaced with MCT oil). After particles were formed and sifted to desired size (75-250 um), the microcapsules were coated in fluid bed with 20% gum Arabic

### Evaluation:

% Payload analysis: Depending on the matrix used, capsules were analyzed for neat flavor content by dissolving capsules in a mixture of either 5% acid or 0.1N alkali solution and dichloromethane.

After separation of the mixture the dichloromethane layer was collected and injected on to a GC for analysis and the flavor components were quantified by external standard curve.

### Mean Results:

| | | |
|---|---|---|
| Initial | Example 1 (EG) | 15.62 |
| | Example 2 (GA) | 8.82 |
| 1 month | Example 1 | 14.228 |
| | Example 2 | 10.394 |

It's important to highlight two things:

1) No significant change in flavor content (payload) as a function of storage time.

2) The tabulated payload above is the neat amount, for total payload actives and diluent is calculated about 23% for the EG type and about 15% for the GA type. To some extent the lower payload in the GA prototype is attributed to further dilution by the addition of gum Arabic.

### Evaluation in Chewing Gum:

Gum Preparation: Sugar-free, slab chewing gum prepared with encapsulated fruit flavor blend described in Examples 1-2 had the following general composition—Base—30%, Polyols—50-55%, Glycerine—5%, Emulsifiers—1%, High Intensity Sweeteners—2%, Acids—2% and Fruit Flavor Blend Encapsulations (liquid flavor was used as a Control)

Procedure: Gum base was melted and combined with emulsifiers in a mixing kettle. Sugar alcohols, glycerin, acids and high intensity sweeteners were added with mixing until a homogenous gum was formed, with the flavor being added last. The mixture was removed from the mixing kettle and rolled and scored to desired piece size.

Gum analysis: Gum samples were placed in a mixture of 5% acid solution and dichloromethane at 1:1 ratio and were left in a shaker until completely dissolved. Dissolved sample solutions were allowed to separate out into two layers and the dichloromethane layer was injected on to the GC for analysis. Quantification of flavor components was done by external standard curve.

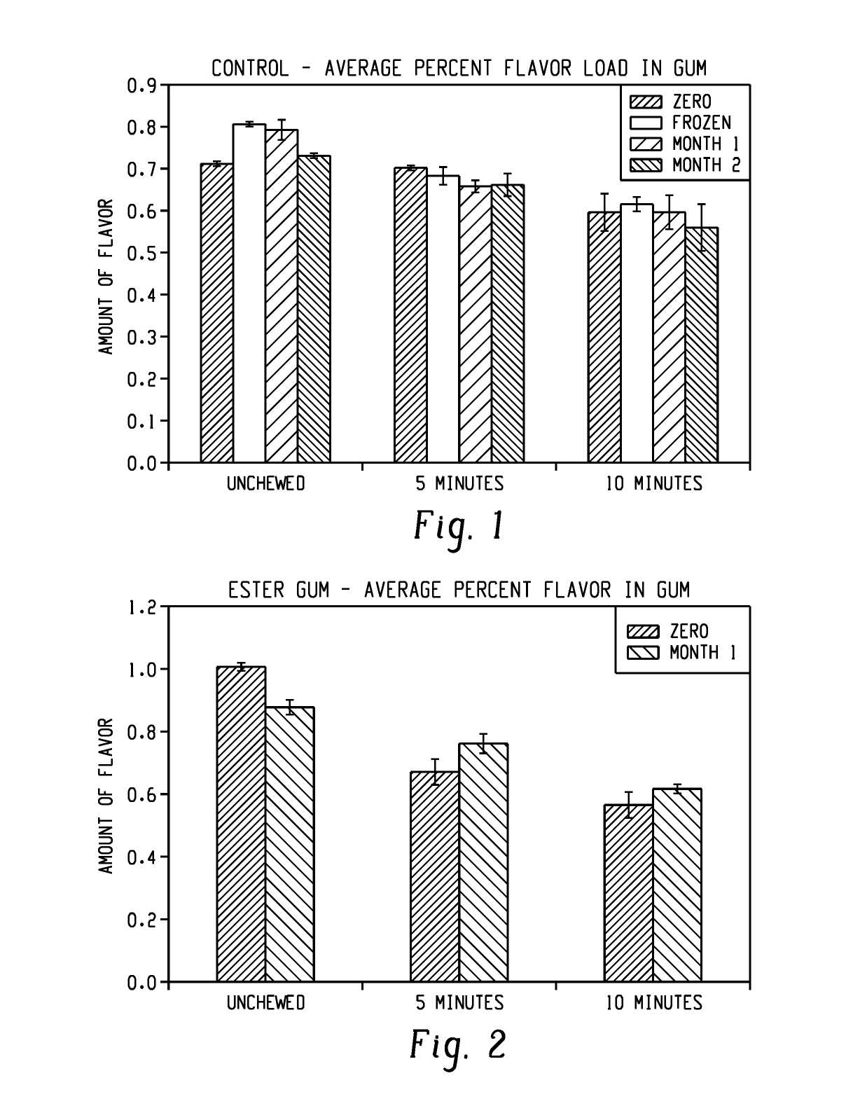

Results: As can be seen from FIGS. 1, 2 and 3, the following is evident:

FIG. 1: Control with liquid flavor (unencapsulated)

Control was incorporated at 1%, the analysis show retention of 0.7-0.8%. After incorporation into gum, the flavor did not change after 1 or 2 months of storage. Comparing to un-chewed, release at 5 and 10 minutes was very low regardless of the age of the gum.

FIG. 2: Microcapsules EG type from Example 1

Amount incorporated was 1% neat flavor based on payload analysis. The amount retained in the gum (un-chewed) was 0.9-1.0, noticeably higher retention than the control. Amount of flavor released at the 5 & 10 minutes is significantly higher than the control (>20% release)

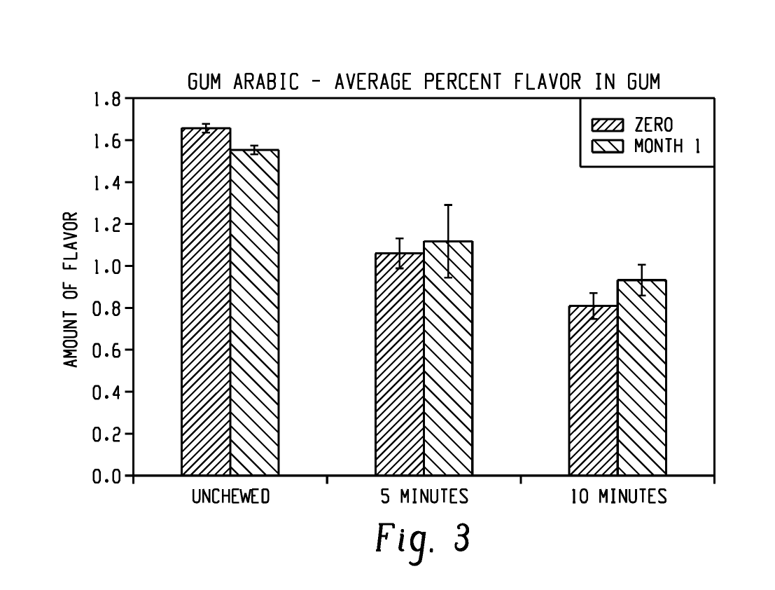

FIG. 3: Microcapsules GA type from Example 2

Amount incorporated was 1.6% neat flavor based on payload analysis. The amount retained in the gum (un-chewed) was about 1.6%, noticeably higher retention than the control. Flavor release at 5 and 10 minutes was about 30% and 50%

This written description uses examples to disclose the invention, including the best mode, and also to enable any person skilled in the art to make and use the invention. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

The present description further includes the following embodiments that further describe the present invention

### Embodiment 1

A chewing gum composition comprising;
(a) a gum base; and (b) at least one microencapsulated composition useful for delivering at least one active component at a desired release rate comprising the at least one active component and a matrix that at least partially microencapsulates the at least one active component; the at least one active component comprising at least one oil-soluble flavoring agent and the matrix comprising dewatered protein precipitate.

### Embodiment 2

The chewing gum composition of embodiment 1 wherein the protein is a milk protein.

### Embodiment 3

The chewing gum composition of embodiment 2 wherein the milk protein is sodium caseinate.

### Embodiment 4

The chewing gum composition of any of embodiments 1 to 3 wherein the at least one oil-soluble flavoring agent is chosen from synthetic flavor oils, natural flavoring aromatics, natural flavoring aromatics oils, oleoresins, extracts derived from plants, leaves, flowers, and fruits.

### Embodiment 5

The chewing gum composition of embodiment 4 wherein the at least one oil-soluble flavoring agent is chosen from spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils, fruit essences, mints, artificial vanilla, cinnamon derivatives, oil-soluble cooling agents, and combinations thereof.

### Embodiment 6

The chewing gum composition of embodiment 4 wherein the at least one oil-soluble flavoring agent is banana oil (isoamyl acetate).

### Embodiment 7

The chewing gum composition of any of embodiments 1 to 6 wherein the at least one oil-soluble flavoring agent is pre-blended with at least one vapor pressure suppressant.

### Embodiment 8

The chewing gum composition of embodiment 7 wherein the at least one vapor pressure suppressant is chosen from at least one medium chain triglyceride (MCT).

### Embodiment 9

The chewing gum composition of embodiment 7 wherein the at least one vapor pressure suppressant is chosen from at least one polyvinyl acetate, at least one ester gum or mixtures thereof.

### Embodiment 10

The chewing gum composition of any of embodiments 7 to 9 wherein the weight ratio of at least one oil-soluble flavoring agent to the at least one the at least one vapor pressure suppressant is from about 20:1 to about 4:1.

### Embodiment 11

The chewing gum composition of any of embodiments 1 to 10 wherein the at least one active component is from about 1% to about 50% by weight of the at least one microencapsulation composition.

### Embodiment 12

The chewing gum composition of any of embodiments 1 to 11 wherein the matrix further comprises at least one film-forming material.

### Embodiment 13

The chewing gum composition of embodiment 12 wherein at least one film-forming material is chosen from shellac or zein or mixtures thereof and the weight ratio of protein to at least one film-forming material is from about 20:1 to about 4:1.

### Embodiment 14

The chewing gum composition of any of embodiments 1 to 13 wherein the matrix further comprises at least one crosslinking agent.

### Embodiment 15

The chewing gum composition of embodiment 14 wherein the crosslinking agent is transglutaminase and the weight ratio of the dewatered protein precipitate to the transglutaminase is from about 20:1 to 4:1.

### Embodiment 16

The chewing gum composition of any of embodiments 1 to 15 wherein the at least one microencapsulated composition further comprises one or more coatings overlying the at least one microencapsulated composition.

### Embodiment 17

The chewing gum composition of any of embodiments 1 to 15 wherein the at least one microencapsulated composition further comprises at least one hydrophobic coating and at least one hydrophilic coating overlying the at least one microencapsulated composition.

### Embodiment 18

The chewing gum composition of embodiment 16 wherein one or more coatings overlying the at least one microencapsulated composition comprises a first hydrophobic coating that completely surrounds the at least one microencapsulated composition.

### Embodiment 19

The chewing gum composition of embodiment 18 wherein the first coating comprises ethyl cellulose.

### Embodiment 20

The chewing gum composition of embodiment 18 wherein the at least one microencapsulated composition further comprises a second coating that substantially surrounds the first coating.

### Embodiment 21

The chewing gum composition of embodiment 20 wherein the second coating comprises a hydrophilic coating chosen from gum arabic, maltodextrin, pectin, gelatin, hydrophilic cellulosic derivatives and mixtures thereof.

### Embodiment 22

The chewing gum composition of embodiment 21 wherein the hydrophilic cellulosic derivatives are chosen from carboxymethyl cellulose, hydroxy methyl cellulose and mixtures thereof.

### Embodiment 23

The chewing gum composition of any of embodiments 1 to 22 wherein the at least one microencapsulated composition has a number average particle size from about 20 microns to about 500 microns

### Embodiment 24

The chewing gum composition of embodiment 23 wherein the at least one microencapsulated composition has a number average particle size from about 70 microns to about 200 microns.

### Embodiment 25

The chewing gum composition of any of embodiments 1 to 24 wherein the at least dewatered protein precipitate is from about 35% to about 90% by weight of the at least one microencapsulation composition.

### Embodiment 26

A chewing gum composition comprising; (a) a gum base; and (b) at least one microencapsulated composition useful for delivering at least one active component at a desired release rate, comprising the at least one active component and a matrix that at least partially microencapsulates the at least one active component; the at least one active component comprising at least one oil-soluble flavoring agent, and at least one vapor suppressant and the matrix comprising dewatered sodium caseinate precipitate and at least one film forming agent; wherein the at least one microencapsulated composition further comprises a first coating that substantially surrounds the at least one active component that is at least partially encapsulated by the matrix; and wherein the at least one microencapsulated composition has a number average particle size from about 20 microns to about 500 microns.

### Embodiment 27

A method for preparing a delivery system for a chewing gum composition comprising: (1) agitating a mixture comprising water and protein material at a pH so that the protein material is soluble in the water to form a solution; (2) mixing a hydrophobic liquid containing an oil-soluble flavoring agent into the solution; (3) homogenizing the hydrophobic liquid and the solution to create an emulsion; (4) acid titrating the emulsion with an amount of acid to form a precipitate of the hydrophobic liquid microcapsulated in the protein material; (5) dewatering the microcapsulated particulated precipitate to form a dried microcapsulated product; and (6) grinding the dried microcapsulated product to a number average particle size of about 20 microns to about 500 microns; thereby forming a delivery system of an oil-soluble flavoring agent microcapsulated in dewatered protein precipitate.

### Embodiment 28

The method of embodiment 27 wherein the protein is a milk protein.

### Embodiment 29

The method of embodiment 28 wherein the milk protein is sodium caseinate.

### Embodiment 30

The method of any of embodiments 27 to 29 wherein the at least one oil-soluble flavoring agent is chosen from synthetic flavor oils, natural flavoring aromatics, natural flavoring aromatics oils, oleoresins, extracts derived from plants, leaves, flowers, fruits and oil-soluble cooling agents.

### Embodiment 31

The method of embodiment 30 wherein the at least one oil-soluble flavoring agent is chosen from spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils, fruit essences, mints, artificial vanilla, cinnamon derivatives, oil-soluble cooling agents and combinations thereof.

### Embodiment 32

The method of embodiment 31 wherein the at least one oil-soluble flavoring agent is banana oil (isoamyl acetate).

### Embodiment 33

The method of any of embodiments 27 to 32 wherein at least one oil-soluble flavoring agent is pre-blended with at least one vapor pressure suppressant.

### Embodiment 34

The method of any of embodiments 27 to 33 wherein at least one vapor pressure suppressant is chosen from at least one medium weight triglyceride, at least one oil-soluble, low molecular weight polymer and mixtures thereof; wherein the weight ratio of at least one oil-soluble flavoring agent to the at least one vapor pressure suppressant is from about 20:1 to about 4:1.

### Embodiment 35

The method of any of embodiments 27 to 34 wherein further film-forming materials chosen from shellac and zein are added to the mixture being homogenized in step (2).

### Embodiment 36

The method of embodiment 35 wherein the weight ratio of protein material to the film-forming materials is from about 20:1 to about 4:1.

### Embodiment 37

The method of any of embodiments 27 to 36 further comprising applying at least two coatings to the delivery system, at least one coating being hydrophilic in nature and at least one being hydrophobic nature.

### Embodiment 38

The method of any of embodiments 27 to 36 further comprising step (7) applying a first hydrophobic coating that substantially surrounds the at least one ground micro encapsulated composition.

### Embodiment 39

The method of embodiment 38 wherein the first coating comprises ethyl cellulose.

### Embodiment 40

The method of any of embodiments 38 or 39 further comprising step (8) applying a second coating that substantially surrounds the first coating.

### Embodiment 41

The method of embodiment 40 wherein the second coating comprises a hydrophilic coating chosen from gum arabic, maltodextrin, pectin and mixtures thereof.

### Embodiment 42

The method of any of embodiments 34 to 41 wherein the low molecular weight polymer is at least one polyvinyl acetate, at least one ester gum or mixtures thereof.

### Embodiment 43

A method of preparing a chewing gum composition containing a delivery system useful for delivering at least one active component at a desired release rate, said method comprising: (1) agitating a mixture comprising water and protein material at a pH so that the protein material is soluble in the water to form a solution; (2) mixing a hydrophobic liquid containing an oil-soluble flavoring agent into the solution; (3) homogenizing the hydrophobic liquid and the solution to create an emulsion; (4) acid titrating the emulsion with an amount of acid to form a precipitate of the hydrophobic liquid microcapsulated in the protein material; (5) dewatering the microcapsulated particulated precipitate to form a dried, free-flowing microcapsulated product; (6) grinding the dried microcapsulated product to a number average particle size of about 70 microns to about 200 microns; thereby forming a delivery system of an oil-soluble flavoring agent microcapsulated in dewatered protein precipitate: and (7) mixing the delivery system with a gum base to yield a chewing gum composition.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A chewing gum composition comprising;
(a) a gum base; and
(b) at least one microencapsulated composition useful for delivering at least one active component at a desired release rate comprising the at least one active component and a matrix that at least partially microencapsulates the at least one active component; the at least one active component comprising at least one oil-soluble flavoring agent and the matrix comprising dewatered milk precipitate.

2. (canceled)

3. The chewing gum composition of claim 1 wherein the milk protein is sodium caseinate.

4. The chewing gum composition of claim 1 wherein the at least one oil-soluble flavoring agent is chosen from synthetic flavor oils, natural flavoring aromatics, natural flavoring aromatics oils, oleoresins, extracts derived from plants, leaves, flowers, and fruits.

5. The chewing gum composition of claim 4 wherein the at least one oil-soluble flavoring agent is chosen from spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, cassia oil, and citrus oils, fruit essences, mints, artificial vanilla, cinnamon derivatives, oil-soluble cooling agents, and combinations thereof.

6. The chewing gum composition of claim 4 wherein the at least one oil-soluble flavoring agent is banana oil (isoamyl acetate).

7. The chewing gum composition of claim 1 wherein the at least one oil-soluble flavoring agent is pre-blended with at least one vapor pressure suppressant.

8. The chewing gum composition of claim 7 wherein the at least one vapor pressure suppressant is chosen from at least one medium chain triglyceride (MCT), at least one polyvinyl acetate, at least one ester gum or mixtures thereof, and wherein the weight ratio of at least one oil-soluble flavoring agent to the at least one the at least one vapor pressure suppressant is from about 20:1 to about 4:1.

9. (canceled)

10. (canceled)

11. The chewing gum composition of claim 1 wherein the at least one active component is from about 1% to about 50% by weight of the at least one microencapsulation composition.

12. The chewing gum composition of claim 1 wherein the matrix further comprises at least one film-forming material.

13. The chewing gum composition of claim 12 wherein at least one film-forming material is chosen from shellac or zein or mixtures thereof and the weight ratio of protein to at least one film-forming material is from about 20:1 to about 4:1.

14. The chewing gum composition of claim 1 wherein the matrix further comprises at least one crosslinking agent and wherein the crosslinking agent is transglutaminase and the weight ratio of the dewatered protein precipitate to the transglutaminase is from about 20:1 to 4:1.

15. (canceled)

16. The chewing gum composition of claim 1 wherein the at least one microencapsulated composition further comprises one or more coatings overlying the at least one microencapsulated composition and wherein one or more coatings overlying the at least one microencapsulated composition comprises a first hydrophobic coating that completely surrounds the at least one microencapsulated composition.

17. (canceled)

18. (canceled)

19. The chewing gum composition of claim 16 wherein the first hydrophobic coating comprises ethyl cellulose.

20. The chewing gum composition of claim 18 wherein the at least one microencapsulated composition further comprises a second hydrophilic coating that substantially surrounds the first hydrophobic coating.

21. The chewing gum composition of claim 20 wherein the second hydrophilic coating comprises gum arabic, maltodextrin, pectin, gelatin, hydrophilic cellulosic derivatives and mixtures thereof.

22. The chewing gum composition of claim 21 wherein the hydrophilic cellulosic derivatives are chosen from carboxymethyl cellulose, hydroxy methyl cellulose and mixtures thereof.

23. The chewing gum composition of claim 1 wherein the at least one microencapsulated composition has a number average particle size from about 20 microns to about 500 microns.

24. The chewing gum composition of claim 23 wherein the at least one microencapsulated composition has a number average particle size from about 70 microns to about 200 microns.

25. The chewing gum composition of claim 1 wherein the at least dewatered milk precipitate is from about 35% to about 90% by weight of the at least one microencapsulation composition.

26. A chewing gum composition comprising;
(a) a gum base; and
(b) at least one microencapsulated composition useful for delivering at least one active component at a desired release rate, comprising the at least one active component and a matrix that at least partially microencapsulates the at least one active component; the at least one active component comprising at least one oil-soluble flavoring agent, and at least one vapor suppressant and the matrix comprising dewatered sodium caseinate precipitate and at least one film forming agent; wherein the at least one microencapsulated composition further comprises a first coating that substantially surrounds the at least one active component that is at least partially encapsulated by the matrix; and wherein the at least one microencapsulated composition has a number average particle size from about 20 microns to about 500 microns.

27. A method for preparing a delivery system for a chewing gum composition comprising:
(1) agitating a mixture comprising water and milk material at a pH so that the protein material is soluble in the water to form a solution;
(2) mixing a hydrophobic liquid containing an oil-soluble flavoring agent into the solution;
(3) homogenizing the hydrophobic liquid and the solution to create an emulsion;
(4) acid titrating the emulsion with an amount of acid to form a precipitate of the hydrophobic liquid microcapsulated in the milk material;
(5) dewatering the microcapsulated particulated precipitate to form a dried microcapsulated product; and
(6) grinding the dried microcapsulated product to a number average particle size of about 20 microns to about 500 microns; thereby forming a delivery system of an oil-soluble flavoring agent microcapsulated in dewatered milk precipitate.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)
